(19) United States
(12) Patent Application Publication
(10) Pub. No.: US 2010/0073637 A1
(43) Pub. Date: Mar. 25, 2010

(54) ILLUMINATING DEVICE AND PROJECTION DISPLAY DEVICE

(75) Inventors: Shinya MATSUMOTO, Hirakata City (JP); Takahisa ANDO, Ikoma City (JP); Takashi IKEDA, Higashi Osaka City (JP); Kiyoko TSUJI, Daito City (JP); Yusuke ITOH, Toyonaka City (JP)

Correspondence Address: MOTS LAW PLLC, Suite 602, 1629 K Street, N.W., Washington, DC, 20006, US

(73) Assignee: SANYO ELECTRIC CO., LTD, Osaka (JP)

(21) Appl. No.: 12/559,565

(22) Filed: Sep. 15, 2009

(30) Foreign Application Priority Data
Sep. 19, 2008 (JP) 2008-241818
Mar. 30, 2009 (JP) 2009-083208

(51) Int. Cl. G03B 21/16; G02B 6/04; G03B 21/20

(52) U.S. Cl. 353/30; 362/554

(57) ABSTRACT

An illuminating device includes a plurality of light source portions for emitting light, a plurality of optical fibers for allowing incidence of the light emitted from the respective light source portions, and a bundling portion for bundling exit ends of the optical fibers. The light source portions or the optical fibers are constructed in such a manner that a flexure of each of the optical fibers is suppressed to mount the each optical fiber in a state close to a straight state. For instance, the light source portions are arranged in an arc shape, with a distance of each of the light source portions with respect to the bundling portion being set as the radius of the arc shape. In this arrangement the respective optical fibers are set to have lengths substantially equal to each other.

This application claims priority under 35 U.S.C. Section 119 of Japanese Patent Application No. 2008-241818 filed Sep. 19, 2008, and Japanese Patent Application No. 2009-083208 filed Mar. 30, 2009. The disclosures of the above applications are incorporated herein by reference.

### BACKGROUND OF THE INVENTION

1. Field of the Invention

The present invention relates to an illuminating device for coupling light from light sources by optical fibers, and a projection display device provided with the illuminating device.

2. Description of the Related Art

Conventionally, there has been known a projection display device (hereinafter, called as a “projector”) for modulating light from a light source based on an image signal, and projecting image light generated by the modulation onto a projection plane. In the projector of this type, as the size of a screen has been increased in recent years, there is an increasing demand for high luminance of image light. Accordingly, there is a demand for securing high luminance of illumination light in an illuminating device to be loaded in the projector.

In view of the above demand, there is proposed an arrangement of integrating light by arranging a large number of light sources one-dimensionally or two-dimensionally into an array or arrays (see e.g. WO99/49358 publication). There is also proposed an arrangement for securing high luminance of illumination light, wherein light from a plurality of light sources is coupled by a plurality of optical fibers, and the optical fibers are bundled to combine light to be emitted from the optical fibers.

FIGS. 21A, 21B, and 21C are diagrams showing an arrangement example of coupling light by using optical fibers. FIGS. 21A and 21B are respectively a side view and a front view of an illuminating device. In FIG. 21B, a bundling portion is omitted to simplify the description. FIG. 21C schematically shows brightness-darkness patterns generated in light emitted from optical fibers.

Referring to FIGS. 21A and 21B, the illuminating device is constituted of a plurality of light source portions 810, a liquid cooled jacket 820, a plurality of optical fibers 830, and a bundling portion 840.

The plurality of light source portions 810 are arranged on a front surface of the liquid cooled jacket 820 in such a manner that the light source portions 810 are arranged in a row at a predetermined interval in Z-axis direction shown in FIG. 21A. Laser light is emitted from the respective light source portions 810.

The liquid cooled jacket 820 includes a heat exchanging portion 821 extending in Z-axis direction, and a flow inlet 822 and a flow outlet 823 respectively formed at both ends of the heat exchanging portion 821. A flow channel is formed with a predetermined pattern inside the heat exchanging portion 821. A cooling liquid drawn through the flow inlet 822 is drawn out through the flow outlet 823 via the flow channel in the heat exchanging portion 821. Thus, the heat exchanging portion 821 is cooled by the cooling liquid to thereby cool the light source portions 810 arranged on the heat exchanging portion 821.

The optical fibers 830 are arranged corresponding to the respective light source portions 810. Laser light emitted from the respective light source portions 810 is entered into incident ends of the respective corresponding optical fibers 830, is propagated through the respective corresponding optical fibers 830, and is emitted through exit ends thereof.

FIGS. 22A and 22B are diagrams showing a connecting portion between one of the light source portions 810 and the corresponding optical fiber 830. FIG. 22A is a top plan view of the light source portion 810, and FIG. 22B is a front view of a laser module 811.

The light source portion 810 includes the laser module 811 and a condenser lens 812. As shown in FIG. 22B, a plurality of emitters (light emission points) 813 are arranged vertically in two rows on the laser module 811.

Laser light emitted from the respective emitters 813 is condensed on the condenser lens 812 for incidence into the optical fiber 830. Specifically, laser light emitted from the laser module 811 is entered into the optical fiber 830 with a predetermined angle distribution. The optical fiber 830 is constituted of a core 831 corresponding to a central portion of the optical fiber 830, and a clad 832 corresponding to a peripheral portion thereof. Laser light entered from an incident surface of the core 831 is propagated through the core 831 by total reflection.

Referring back to FIGS. 21A and 21B, all the optical fibers 830 are bundled by the bundling portion 840 on the side of the exit ends of the optical fibers 830. Thus, the laser light from the respective light source portions 810 is collected by the optical fibers 830, and the laser light having a high luminance is emitted in a forward direction from a front end of the bundling portion 840.

In the above example, all the optical fibers 830 are set to have length substantially equal to each other. The optical fibers 830 are bundled by the bundling portion 840 in such a manner that exit end surfaces of the optical fibers 830 are aligned to each other. The bundling portion 840 is disposed at such a position that the center thereof is substantially aligned with an arrangement center of the light source portions 810. Accordingly, as shown in FIG. 21A, although the optical fibers 830 located at an outermost position with respect to the arrangement center are mounted in a straight state, the optical fibers 830 located close to the arrangement center are mounted in a flexed or bent state. In this case, the optical fiber 830 located closer to the arrangement center is likely to bend greatly. In particular, if the distance between the respective light source portions 810 and the bundling portion 840 is reduced to miniaturize the illuminating device, a bending degree of the optical fibers 830 located close to the arrangement center is increased.

As shown in FIG. 22A, in the case where laser light emitted from the plurality of emitters 813 is condensed for incidence into the optical fibers 830, if the optical fibers 830 are bent to a state equal to or smaller than an allowable bend radius, laser light to be emitted from the exit ends of the respective optical fibers 830 have brightness-darkness patterns, as shown in FIG. 21C, based on the angle distribution of laser light. In the case where the optical fibers 830 are bent at a certain portion on the way to the bundling portion 840, the angle distribution of laser light is changed, because a reflection state of laser light (reflection angle with respect to an inner wall of the core) at the bent portion is changed. As a result, the brightness-darkness pattern is changed.

Accordingly if the bending degrees of the respective optical fibers 830 are different from each other, as shown in FIG. 21A, there is a likelihood that a large difference in brightness-darkness pattern may be generated between laser light to be emitted from an optical fiber 830 close to the arrangement center and an optical fiber 830 away from the arrangement center.

For instance, in the optical fiber 830 closest to the arrangement center and having a largest bending degree, as shown in FIG. 21C, a brightness-darkness pattern “A” is generated; and in the optical fiber 830 which is located at the outermost position with respect to the arrangement center and is mounted in a straight state, as shown in FIG. 21C, a brightness-darkness pattern “B” having a larger difference between brightness and darkness, as compared with the pattern “A”, is generated.

In this way, if light to be emitted from the respective optical fibers 830 has a brightness-darkness pattern with a large difference in brightness and darkness, or a brightness-darkness pattern is greatly changed depending on the optical fibers 830, a brightness nonuniformity (luminance nonuniformity) may occur in combined light (illumination light) to be emitted from the front end of the bundling portion 840.

In the case where the illuminating device having the above drawback is loaded in a projector, a brightness nonuniformity may occur in a projected image by the projector.

### SUMMARY OF THE INVENTION

An illuminating device according to a first aspect of the present invention includes: a plurality of light source portions (light source portions 100) for emitting light; a plurality of optical fibers (optical fibers 300) for guiding the light emitted from the respective light source portions to an object to be illuminated; and a bundling portion (bundling portion 400) for bundling the optical fibers, wherein an arrangement for suppressing a flexure of each of the optical fibers in the case where the each optical fiber is mounted between the corresponding light source portion and the bundling portion is provided on both or either one of the light source portion and the optical fiber.

In the illuminating device according to the first aspect, the light source portions may be arranged at such positions that the light source portion located farther away from a central axis of the bundling portion in a direction perpendicular to the central axis has a reduced distance with respect to the bundling portion in a direction parallel to the central axis.

Also, in the illuminating device according to the first aspect, the light source portions may be arranged in an arc shape or a substantially arc shape to make distances between the respective light source portions and the bundling portion substantially equal to each other.

Further, in the illuminating device according to the first aspect, the respective optical fibers may be set to have lengths different from each other depending on the distances from the respective light source portions to the bundling portion.

According to the arrangement of the first aspect, since a flexure of each of the optical fibers is suppressed, and each of the optical fibers is mounted in a state close to a straight state, a large difference in brightness-darkness pattern of light from the optical fibers can be suppressed. Accordingly, a luminance nonuniformity of illumination light can be easily reduced by additionally providing optical means for suppressing a brightness-darkness pattern.

A second aspect of the present invention relates to a projection display device. The projection display device is provided with the illuminating device according to the first aspect. Accordingly, similarly to the first aspect, a luminance nonuniformity of illumination light can be reduced, and precision of a projected image can be enhanced.

### BRIEF DESCRIPTION OF THE DRAWINGS

The foregoing and other objects, and novel features of the present invention will become more apparent upon reading the following detailed description of the embodiment along with the accompanying drawings.

FIGS. 1A, 1B, and 1C are diagrams showing an arrangement of an illuminating device as a first embodiment of the present invention.

FIGS. 2A, 2B, 2C, and 2D are diagrams showing arrangements of an illuminating device as a first modification and a second modification of the first embodiment.

FIGS. 3A and 3B are diagrams showing an arrangement of an illuminating device as a third modification of the first embodiment.

FIGS. 4A and 4B are diagrams showing an arrangement of an illuminating device as a fourth modification of the first embodiment.

FIGS. 5A and 5B are diagrams showing an arrangement of an illuminating device as a second embodiment of the present invention.

FIGS. 6A and 6B are diagrams showing an arrangement of an illuminating device as a third embodiment of the present invention.

FIG. 7 is a perspective view showing a detailed arrangement example (Example 1) of a projector to which the illuminating devices of the first embodiment, the second embodiment, and the third embodiment are applied.

FIG. 8 is a side view of the projector shown in FIG. 7.

FIG. 9 is a top plan view of the projector shown in FIG. 7.

FIG. 10 is a diagram showing an arrangement of a light source unit provided in the projector shown in FIG. 7.

FIG. 11 is a diagram showing a part of the light source unit provided in the projector shown in FIG. 7.

FIG. 12 is a diagram showing an arrangement of an optical engine and a projection unit provided in the projector shown in FIG. 7.

FIG. 13 is a diagram showing a part of a light source unit in a detailed arrangement example (Example 2) of the illuminating device as the first embodiment.

FIG. 14 is a diagram showing a part of a light source unit in a detailed arrangement example (Example 3) of the illuminating device as the first embodiment.

FIG. 15 is a diagram showing a part of a light source unit in a detailed arrangement example (Example 4) of the illuminating device as the first embodiment.

FIG. 16 is a diagram showing a part of a light source unit in a detailed arrangement example (Example 5) of the illuminating device as the third embodiment.

FIGS. 17A, 17B, 17C, and 17D are diagrams showing arrangements of an illuminating device as Reference Example 1.

FIGS. 18A, 18B, 18C, and 18D are diagrams showing arrangements of an illuminating device as Reference Example 2.

FIGS. 19A, 19B, and 19C are diagrams showing arrangements of an illuminating device as Reference Example 3.

FIGS. 20A, 20B, and 20C are diagrams showing arrangements of an illuminating device as Reference Example 4.

FIGS. 21A, 21B, and 21C are diagrams showing an arrangement example of an illuminating device incorporated with optical fibers according to the related art.

FIGS. 22A and 22B are diagrams showing an arrangement example of a light source portion according to the related art.

The drawings are provided mainly for describing the present invention, and do not limit the scope of the present invention.

### DESCRIPTION OF THE PREFERRED EMBODIMENTS

In the following, embodiments of the present invention are described referring to the drawings.

### First Embodiment

### Summary of Illuminating Device

The illuminating device as the first embodiment includes a plurality of light source portions (light source portions 100) for emitting light, a plurality of optical fibers (optical fibers 300) for guiding the light emitted from the respective light source portions to an object to be illuminated, and a bundling portion (bundling portion 400) for bundling the optical fibers. An arrangement for suppressing a flexure of each of the optical fibers in the case where the each optical fiber is mounted between the corresponding light source portion and the bundling portion is provided on both or either one of the light source portion and the optical fiber.

Specifically, according to the arrangement of the illuminating device as the first embodiment, the light source portions are arranged at such positions that the light source portion farther away from a central axis of the bundling portion in a direction (e.g. Z-axis direction) perpendicular to the central axis has a reduced distance with respect to the bundling portion in a direction (e.g. X-axis direction) parallel to the central axis.

### Arrangement of Illuminating Device

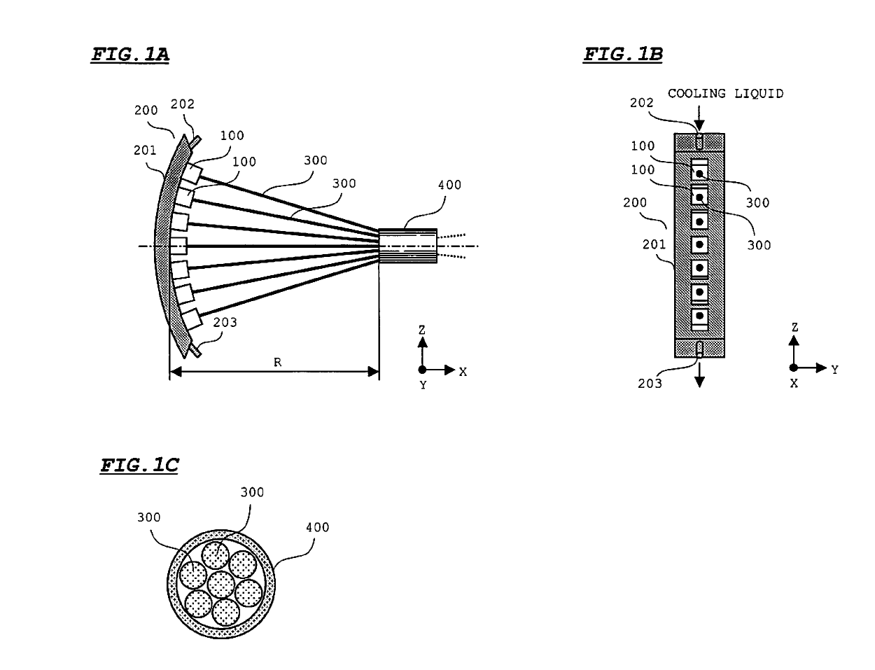

FIGS. 1A, 1B, and 1C are diagrams showing an arrangement of the illuminating device as the first embodiment. FIGS. 1A and 1B are respectively a side view and a front view of the illuminating device. In FIG. 1B, a bundling portion is omitted to simplify the description. FIG. 1C is a front view of the bundling portion, and optical fibers bundled by the bundling portion.

Referring to FIGS. 1A, 1B, and 1C, the illuminating device is constituted of a plurality of light source portions 100, a liquid cooled jacket 200, a plurality of optical fibers 300, and a bundling portion 400.

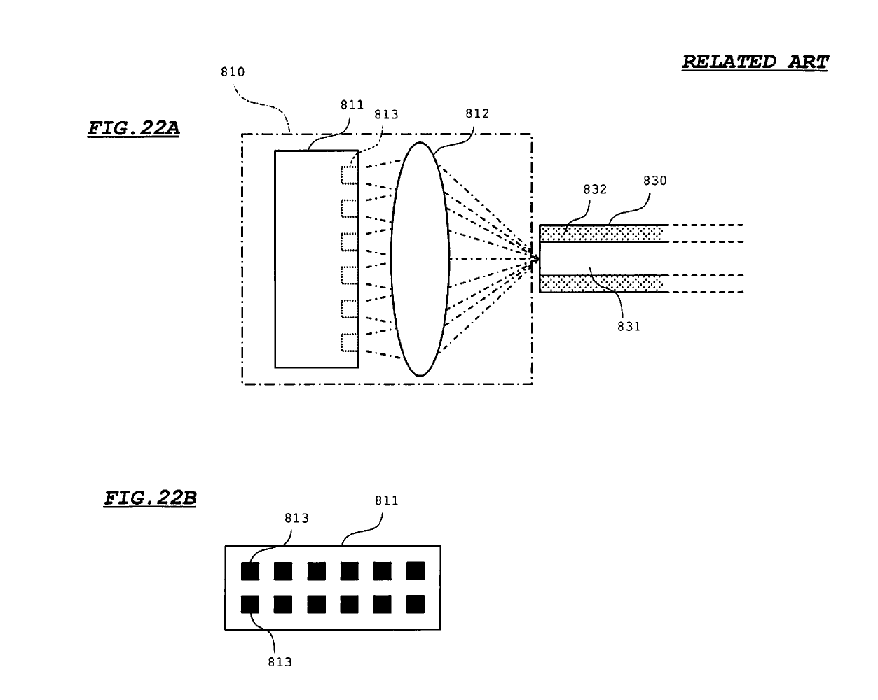

The plurality of (e.g. seven) light source portions 100 are mounted on a mounting surface of the liquid cooled jacket 200 in such a manner that the light source portions 100 are arranged in a row in Z-axis direction in FIG. 1A at a predetermined interval. The arrangement of each of the light source portions 100 is substantially the same as the arrangement shown in FIGS. 22A and 22B.

The liquid cooled jacket 200 includes a heat exchanging portion 201 extending in Z-axis direction, and a flow inlet 202 and a flow outlet 203 respectively formed at both ends of the heat exchanging portion 201. As viewed from a side direction, the heat exchanging portion 201 is formed into an arc shape, with a distance R thereof with respect to the bundling portion 400 being set as the curvature radius of the arc shape. A flow channel is formed with a predetermined pattern in the heat exchanging portion 201. A cooling liquid drawn through the flow inlet 202 is drawn out through the flow outlet 203 via the flow channel in the heat exchanging portion 201. Thus, the heat exchanging portion 201 is cooled by the cooling liquid to thereby cool the light source portions 100 arranged on the heat exchanging portion 201.

The respective optical fibers 300 are arranged corresponding to the respective light source portions 100. Laser light emitted from the respective light source portions 100 is entered into incident ends of the respective corresponding optical fibers 300, is propagated through the respective corresponding optical fibers 300, and emitted through exit ends thereof. All the optical fibers 300 are set to have lengths substantially equal to each other.

All the optical fibers 300 are bundled into a fiber bundle by the bundling portion 400 on the side of the exit ends thereof. The bundling portion 400 is made of a material such as a metal or a resin to have a cylindrical shape. As shown in FIG. 1C, the optical fibers 300 are bundled into such a shape as to correspond to the hole configuration of the bundling portion 400. Laser light from the respective light source portions 100 is collected by the optical fibers 300. Laser light (illumination light) of high luminance by the collection is emitted in a forward direction (X-axis direction) from a front end of the bundling portion 400.

Since the liquid cooled jacket 200 is formed into an arc shape, with the distance R thereof with respect to the bundling portion 400 being set as the curvature radius of the arc shape, as described above, the distances between the respective light source portions 100 mounted on the liquid cooled jacket 200 and the bundling portion 400 are made substantially equal to each other. Accordingly, as shown in FIG. 1A, all the optical fibers 300 are mounted in a straight state.

As described above, in this embodiment, the light source portions 100 are arranged into an arc shape with respect to the bundling portion 400 to make the distances between the respective light source portions 100 and the bundling portion 400 substantially equal to each other.

Accordingly, there is no likelihood that a large difference in brightness-darkness pattern may be generated in laser light to be emitted from the optical fibers 300. Thus, since the brightness-darkness pattern of illumination light to be emitted from the front end of the bundling portion 400 becomes substantially uniform, a luminance nonuniformity of illumination light can be easily reduced by arranging optical means for suppressing a brightness-darkness pattern as described above, as necessary.

In this embodiment, the light source portions 100 are one-dimensionally arranged with respect to the liquid cooled jacket 200. Alternatively, the light source portions 100 may be arranged two-dimensionally or three-dimensionally. In the following, a first modification through a fourth modification are described, wherein light source portions 100 are arranged three-dimensionally.

### First Modification

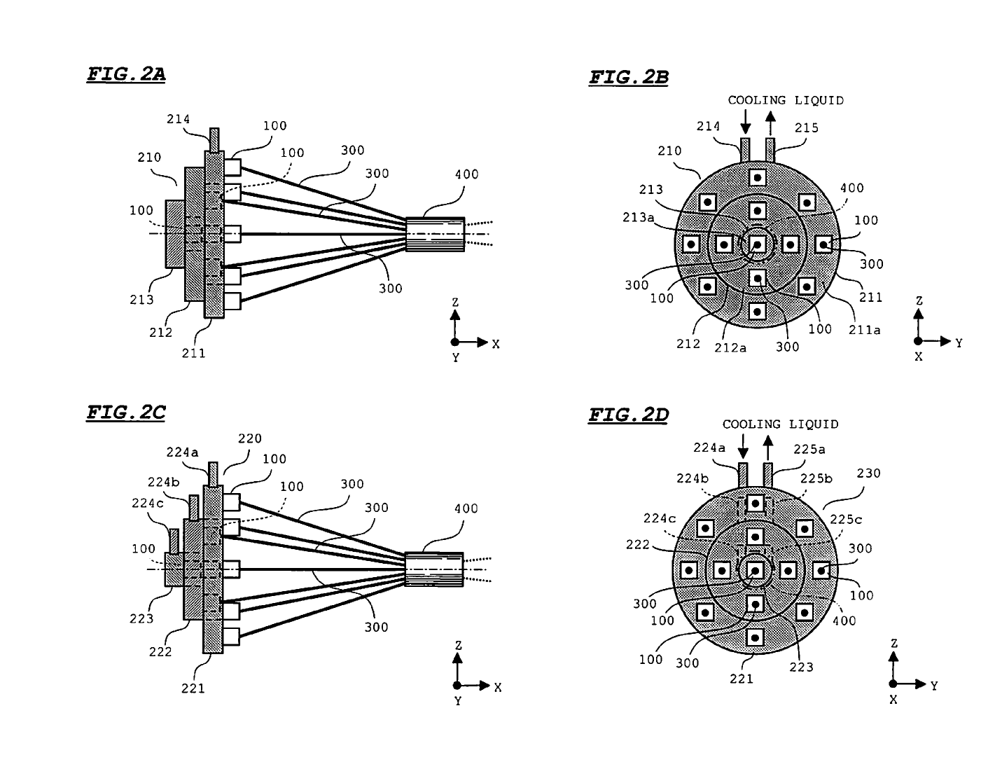

FIGS. 2A, 2B, 2C, and 2D are diagrams showing illuminating devices as the first modification and the second modification of the first embodiment. FIGS. 2A and 2B are respectively a side view and a front view of the illuminating device as the first modification. In FIG. 2B, a bundling portion is omitted to simplify the description.

Referring to FIGS. 2A and 2B, the illuminating device as the first modification includes a liquid cooled jacket 210. The liquid cooled jacket 210 has a first heat exchanging portion 211, a second heat exchanging portion 212, a third heat exchanging portion 213, a flow inlet 214, and a flow outlet 215.

The first heat exchanging portion 211 is formed into a circular annular shape, and the second heat exchanging portion 212 is formed into a circular annular shape whose outer diameter is smaller than the outer diameter of the first heat exchanging portion 211. The third heat exchanging portion 213 is formed into a circular shape whose outer diameter is smaller than the outer diameter of the second heat exchanging portion 212. The first through the third heat exchanging portions 211 through 213 are integrally mounted to each other in such a state that the second heat exchanging portion 212 is disposed at a rear surface of the first heat exchanging portion 211, and the third heat exchanging portion 213 is disposed at a rear surface of the second heat exchanging portion 212. Accordingly, the one liquid cooled jacket 210 is constructed.

The flow inlet 214 and the flow outlet 215 are formed in the first heat exchanging portion 211. A flow channel formed in the liquid cooled jacket 210 has a predetermined pattern in the first heat changing portion 211, the second heat exchanging portion 212, and the third heat exchanging portion 213 in such a manner that a cooling liquid is allowed to flow in the order of the flow inlet 214, the first heat exchanging portion 211, the second heat exchanging portion 212, the third heat exchanging portion 213, the second heat exchanging portion 212, the first heat exchanging portion 211, and the flow outlet 215.

A plurality of (e.g. eight) light source portions 100 are mounted on a mounting surface 211a of the first heat exchanging portion 211 at a substantially equal interval. Amounting surface 212a of the second heat exchanging portion 212 faces forward from a middle opening of the first heat exchanging portion 211. A plurality of (e.g. four) light source portions 100 are mounted on the mounting surface 212a at a substantially equal interval. A mounting surface 213a of the third heat exchanging portion 213 faces forward from a middle opening of the second heat exchanging portion 212. One light source portion 100 is mounted on the mounting surface 213a.

Respective optical fibers 300 are arranged corresponding to the respective light source portions 100. Exit ends of the optical fibers 300 are bundled by a bundling portion 400. The arrangements of the light source portions 100, the optical fibers 300, and the bundling portion 400 are substantially the same as the corresponding arrangements in the embodiment. All the optical fibers 300 are set to have lengths substantially equal to each other. The center of the bundling portion 400 is substantially aligned with the center of the liquid cooled jacket 210 in a state that the optical fibers 300 are bundled by the bundling portion 400.

The positions of the mounting surface 211a of the first heat exchanging portion 211, the mounting surface 212a of the second heat exchanging portion 212, and the mounting surface 213a of the third heat exchanging portion 213 in X-axis direction are set in such a manner that the distances between the bundling portion 400 and the light source portions on the respective mounting surfaces are set substantially equal to each other. Accordingly, since the distances between all the light source portions 100 and the bundling portion 400 are set substantially equal to each other, all the optical fibers 300 are mounted in a straight state.

As described above, in the arrangement of the first modification, the light source portions 100 are arranged in an arc shape with respect to the bundling portion 400 so that the distances between the respective light source portions 100 and the bundling portion 400 are made substantially equal to each other.

Thus, similarly to the embodiment, since there is no likelihood that a large difference in brightness-darkness pattern may be generated in light to be emitted from the optical fibers 300 in the arrangement of the first modification, a luminance nonuniformity of illumination light can be easily reduced by arranging optical means for suppressing a brightness-darkness pattern as described above, as necessary.

### Second Modification

FIGS. 2C and 2D are respectively a side view and a front view of the illuminating device as the second modification. In FIG. 2D, a bundling portion is omitted to simplify the description.

The illuminating device as the second modification is different from the arrangement of the first modification in that a first heat exchanging portion 221, a second heat exchanging portion 222, and a third heat exchanging portion 223 constituting a liquid cooled jacket 220 are individually and independently provided, instead of being integrally provided. In view of this, flow channels in the liquid cooled jacket 220 are individually and independently formed. Also, a flow inlet 224a and a flow outlet 225a are formed in the first heat exchanging portion 221; a flow inlet 224b and a flow outlet 225b are formed in the second heat exchanging portion 222; and a flow inlet 224c and a flow outlet 225c are formed in the third heat exchanging portion 223, respectively.

The outer diameter of the second heat exchanging portion 222 is set slightly smaller than a middle opening of the first heat exchanging portion 221, and the outer diameter of the third heat exchanging portion 223 is set slightly smaller than a middle opening of the second heat exchanging portion 222. The other arrangement of the second modification is substantially the same as the corresponding arrangement of the first modification.

Similarly to the arrangement of the first modification, all the optical fibers 300 are mounted in a straight state in the arrangement of the second modification. Accordingly, similarly to the embodiment, since there is no likelihood that a large difference in brightness-darkness pattern may be generated in laser light to be emitted from the optical fibers 300, a luminance nonuniformity of illumination light can be easily reduced by arranging optical means for suppressing a brightness-darkness pattern as described above, as necessary.

Also, in the arrangement of the second modification, the first heat exchanging portion 221, the second heat exchanging portion 222, and the third heat exchanging portion 223 are individually and independently provided. Accordingly, the positions of the respective heat exchanging portions in X-axis direction in FIG. 2C can be adjusted, as necessary, to mount the respective optical fibers 300 in a straight state.

### Third Modification

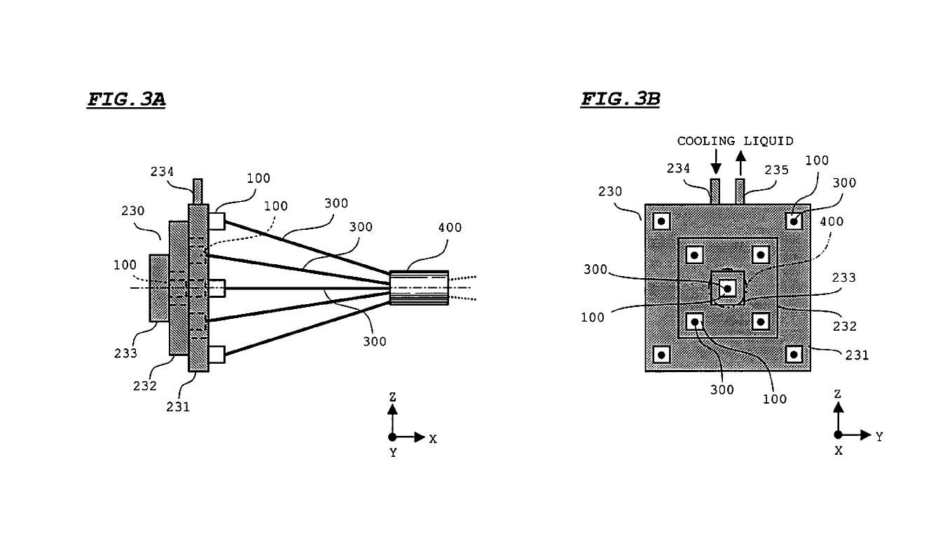

FIGS. 3A and 3B are diagrams showing the third modification of the first embodiment. FIGS. 3A and 3B are respectively a side view and a front view of the illuminating device as the third modification. In FIG. 3B, a bundling portion is omitted to simplify the description.

The illuminating device as the third modification is different from the arrangement of the first modification in that a first heat exchanging portion 231 and a second heat exchanging portion 232 are each formed into a square annular shape, and a third heat exchanging portion 233 is formed into a square shape. Respective light source portions 100 are mounted on corner portions of the first heat exchanging portion 231 and the second heat exchanging portion 232 to make the distances between the respective light source portions 100 mounted on the first heat exchanging portions 231 and the second heat exchanging portion 232 and a bundling portion 400 substantially equal to each other. The other arrangement of the third modification is substantially the same as the corresponding arrangement of the first modification.

Similarly to the arrangement of the first modification, all the optical fibers 300 are mounted in a straight state in the arrangement of the third modification. Accordingly, similarly to the embodiment, since there is no likelihood that a large difference in brightness-darkness pattern may be generated in laser light to be emitted from the optical fibers 300, a luminance nonuniformity of illumination light can be easily reduced by arranging optical means for suppressing a brightness-darkness pattern as described above, as necessary.

Also, since the heat exchanging portion 231, 232, 233 has a rectangular shape, a liquid cooled jacket 230 can be easily produced, as compared with a case that the heat exchanging portion 231, 232, 233 has a circular shape.

Further alternatively, the light source portions 100 on the first heat exchanging portion 231 and the second heat exchanging portion 232 may be arranged on middle portions on the respective sides of the first heat exchanging portion 231 and the second heat exchanging portion 232, instead of the corner portions. The modification also enables to set the distances between the respective light source portions 100 and the bundling portion 400 substantially equal to each other.

### Fourth Modification

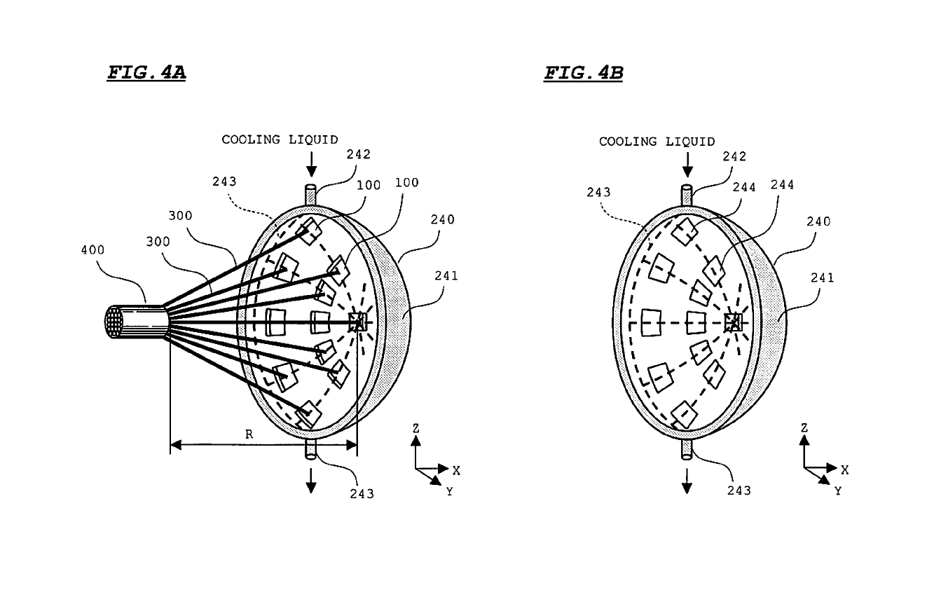

FIGS. 4A and 4B are diagrams showing an illuminating device as the fourth modification of the first embodiment. FIG. 4A is a perspective view of the illuminating device, and FIG. 4B is a perspective view of a liquid cooled jacket.

The illuminating device as the fourth modification includes a liquid cooled jacket 240. The liquid cooled jacket 240 has a heat exchanging portion 241 formed into a cup shape, and a flow inlet 242 and a flow outlet 243 for a cooling liquid, which are formed in the heat exchanging portion 241. The inner surface of the heat exchanging portion 241 has a spherical shape, and a bundling portion 400 is disposed at such a position that a distance R of the heat exchanging portion 241 with respect to the bundling portion 400 is set as the curvature radius of the inner surface configuration. A flow channel 243 is formed with a predetermined pattern in the heat exchanging portion 241.

A plurality of light source portions 100 are radially (concentrically) arranged on the inner surface (mounting surface) of the heat exchanging portion 241. Optical fibers 300 are arranged corresponding to the respective light source portions 100, and exit ends of the optical fibers 300 are bundled by the bundling portion 400. The arrangements of the light source portions 100, the optical fibers 300, and the bundling portion 400 are substantially the same as the corresponding arrangements in the embodiment.

All the optical fibers 300 are set to have lengths substantially equal to each other. Further, the center of the bundling portion 400 is substantially aligned with the center of the liquid cooled jacket 240 in a state that the optical fibers 300 are bundled by the bundling portion 400.

As described above, the inner surface of the liquid cooled jacket 240 has a spherical shape, with the distance R with respect to the bundling portion 400 being set substantially equal to the curvature radius of the inner surface configuration. Accordingly, the distances between the respective light source portions 100 mounted on the liquid cooled jacket 240 and the bundling portion 400 are made substantially equal to each other. Accordingly, as shown in FIG. 4A, all the optical fibers 300 are mounted in a straight state.

As described above, in the arrangement of the fourth modification, the light source portions 100 are arranged in an arc shape with respect to the bundling portion 400 to make the distances between the respective light source portions 100 and the bundling portion 400 substantially equal to each other.

Accordingly, similarly to the embodiment, there is no likelihood that a large difference in brightness-darkness pattern may be generated in laser light to be emitted from the optical fibers 300 in the arrangement of the fourth modification. Accordingly, a luminance nonuniformity of illumination light can be easily reduced by arranging optical means for suppressing a brightness-darkness pattern as described above, as necessary.

As shown in FIG. 4B, heat releasing fins 244 are provided on the inner surface (mounting surface) of the heat exchanging portion 241, at the arrangement positions of the respective corresponding light source portions 100. This enables to enhance the heat releasing effect of the light source portions 100.

### Second Embodiment

### Summary of Illuminating Device

The illuminating device as the second embodiment includes a plurality of light source portions (light source portions 100) for emitting light, a plurality of optical fibers (optical fibers 300) for guiding the light emitted from the respective light source portions to an object to be illuminated, and a bundling portion (bundling portion 400) for bundling the optical fibers. An arrangement for suppressing a flexure of each of the optical fibers in the case where the each optical fiber is mounted between the corresponding light source portion and the bundling portion is provided on both or either one of the light source portion and the optical fiber.

Specifically, according to the arrangement of the illuminating device as the second embodiment, the light source portions are arranged in an arc shape or a substantially arc shape to make the distances between the respective light source portions and the bundling portion substantially equal to each other.

### Arrangement of Illuminating Device

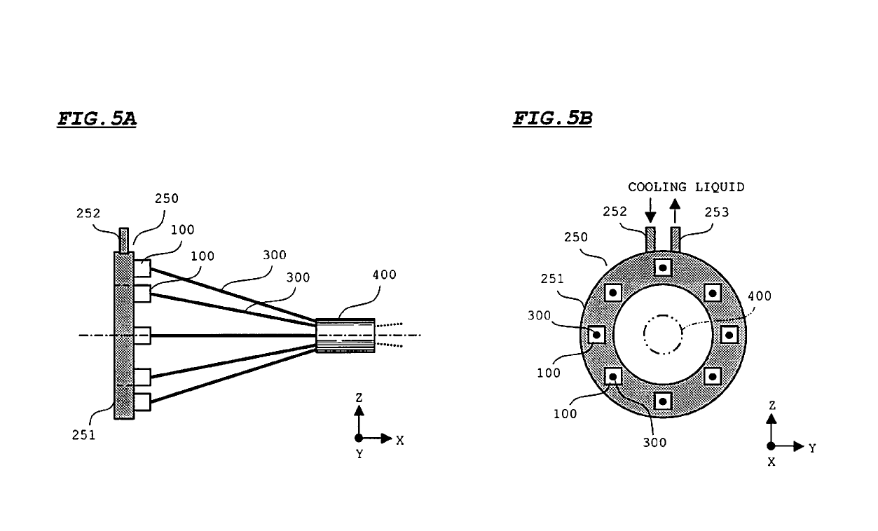

FIGS. 5A and 5B are diagrams showing an arrangement of an illuminating device as the second embodiment. FIGS. 5A and 5B are respectively a side view and a front view of the illuminating device. In FIG. 5B, a bundling portion is omitted to simplify the description.

The illuminating device includes a liquid cooled jacket 250. As shown in FIG. 5B, the liquid cooled jacket 250 includes a heat exchanging portion 251 formed into a circular annular shape viewed from a front direction, and a flow inlet 252 and a flow outlet 253 for a cooling liquid, which are formed in the heat exchanging portion 251. A flow channel is formed with a predetermined pattern in the heat exchanging portion 251.

A plurality of (e.g. eight) light source portions 100 are mounted on a mounting surface of the heat exchanging portion 251 at a substantially equal interval. Optical fibers 300 are arranged corresponding to the respective light source portions 100, and exit ends of the optical fibers 300 are bundled by a bundling portion 400. The arrangements of the light source portions 100, the optical fibers 300, and the bundling portion 400 are substantially the same as the corresponding arrangements of the first embodiment.

All the optical fibers 300 are set to have lengths substantially equal to each other. Further, the center of the bundling portion 400 is substantially aligned with the center of the liquid cooled jacket 250 in a state that the optical fibers 300 are bundled by the bundling portion 400. Accordingly, since the distances between the respective light sources 100 and the bundling portion 400 are made substantially equal to each other, all the optical fibers 300 are mounted in a straight state.

As described above, in the second embodiment, the light source portions 100 are arranged in an arc shape with respect to the bundling portion 400 to make the distances between the respective light source portions 100 and the bundling portion 400 substantially equal to each other.

Accordingly, similarly to the first embodiment, there is no likelihood that a large difference in brightness-darkness pattern may be generated in laser light to be emitted from the optical fibers 300 in the second embodiment. Accordingly, a luminance nonuniformity of illumination light can be easily reduced by arranging optical means for suppressing a brightness-darkness pattern as described above, as necessary.

### Third Embodiment

### Summary of Illuminating Device

The illuminating device as the third embodiment includes a plurality of light source portions (light source portions 100) for emitting light, a plurality of optical fibers (optical fibers 300) for guiding the light emitted from the respective light source portions to an object to be illuminated, and a bundling portion (bundling portion 400) for bundling the optical fibers. An arrangement for suppressing a flexure of each of the optical fibers in the case where the each optical fiber is mounted between the corresponding light source portion and the bundling portion is provided on both or either one of the light source portion and the optical fiber.

Specifically, according to the arrangement of the illuminating device as the third embodiment, the optical fibers are set to have different lengths (310a, 310b, 310c, and 310d) depending on the distances from the respective light source portions to the bundling portion.

### Arrangement of Illuminating Device

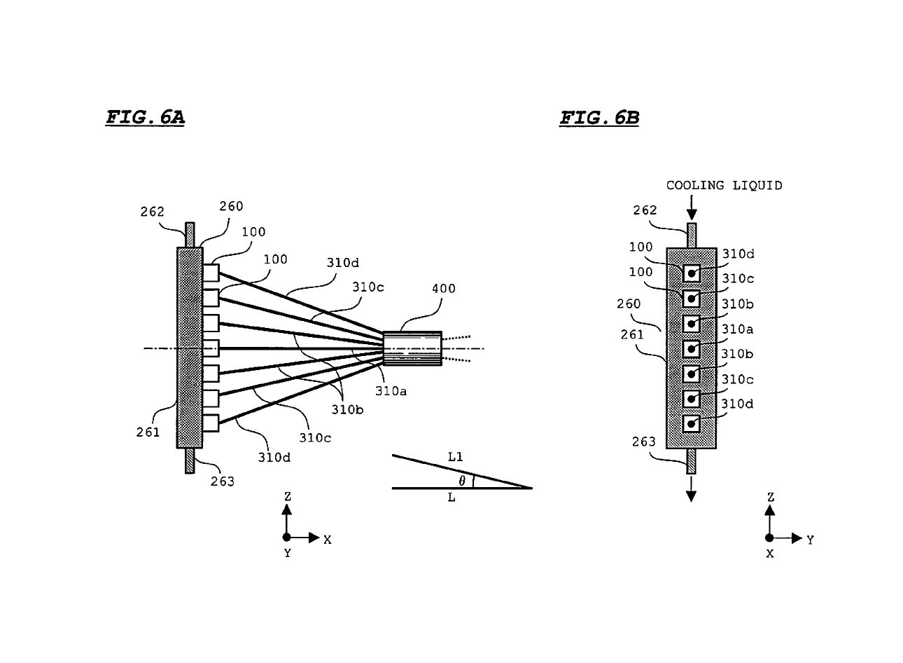

FIGS. 6A and 6B are diagrams showing an arrangement of the illuminating device as the third embodiment. FIGS. 6A and 6B are respectively a side view and a front view of the illuminating device. In FIG. 6B, a bundling portion is omitted to simplify the description.

Referring to FIGS. 6A and 6B, the illuminating device is constituted of a plurality of light source portions 100, a liquid cooled jacket 260, a plurality of optical fibers 310a, 310b, 310c, and 310d, and a bundling portion 400.

The plurality of (e.g. seven) light source portions 100 are mounted on a mounting surface of the liquid cooled jacket 260 in such a manner that the light source portions 100 are arranged in a row in Z-axis direction in FIG. 6A at a predetermined interval. The arrangement of the light source portion 100 is substantially the same as the arrangement in the first embodiment.

The liquid cooled jacket 260 includes a heat exchanging portion 261 extending in Z-axis direction and having a flat mounting surface, and a flow inlet 262 and a flow outlet 263 respectively formed on both ends of the heat exchanging portion 261. A flow channel is formed with a predetermined pattern in the heat exchanging portion 260. A cooling liquid drawn through the flow inlet 262 is drawn out through the flow outlet 263 via the flow channel in the heat exchanging portion 261. Thus, the heat exchanging portion 261 is cooled by the cooling liquid to thereby cool the light source portions 100 arranged on the heat exchanging portion 261.

The optical fibers 310a through 310d are arranged corresponding to the respective light source portions 100. Laser light emitted from the respective light source portions 100 is entered into incident ends of the respective corresponding optical fibers 310a through 310d, is propagated through the respective corresponding optical fibers 310a through 310d, and emitted through exit ends thereof.

The lengths of the respective optical fibers 310a, 310b, 310c, and 310d are adjusted to be mounted in a straight state. For instance, in the case where the length of the optical fiber 310a located at a center of the optical fiber arrangement with respect to the bundling portion 400 is set to “L”, the length L1 of the other optical fiber 310b, 310c, 310d with respect to the bundling portion 400 can be calculated by the equation: L1=L/cos θ, where θ is an angle of the other optical fiber with respect to the optical fiber 310a.

All the optical fibers 310a through 310d are bundled by the bundling portion 400 on the side of the exit ends thereof. The arrangement of the bundling portion 400 is substantially the same as the corresponding arrangement in the first embodiment. Thus, laser light (illumination light) of high luminance obtained by collecting the laser light from the respective light source portions 100 through the optical fibers 310a through 310d is emitted in forward direction (X-axis direction) from a front end of the bundling portion 400.

As described above, according to the third embodiment, since all the optical fibers 310a through 310d are mounted in a straight state, there is no likelihood that a large difference in brightness-darkness pattern may be generated in laser light to be emitted from the optical fibers 310a through 310d. Accordingly, a luminance nonuniformity of illumination light can be easily reduced by arranging optical means for suppressing a brightness-darkness pattern as described above, as necessary.

### Detailed Arrangement Examples

The first embodiment and the modifications thereof, the second embodiment, and the third embodiment have been described in the foregoing section. Detailed arrangement examples of the inventive illuminating device may be modified based on these embodiments, as necessary. For instance, FIGS. 1A through 5B show a state that the optical fibers 300 are mounted in a stretched state. In an actual illuminating device, however, the optical fibers 300 may be mounted in a slightly flexed state. Specifically, in an actual illuminating device, the optical fibers 300 are arranged in such a manner that an incident end and an exit end of each of the optical fibers 300 are respectively aligned substantially in parallel to an optical axis of the corresponding light source portion 100 and the central axis of the bundling portion 400. Accordingly, the respective optical fibers 300 are mounted in a slightly flexed state. The modified arrangement may also be applied to the illuminating device shown in FIGS. 6A and 6B. In the modification, the respective optical fibers 300 are mounted in a state close to a straight state, with a flexure thereof being suppressed as much as possible, and are arranged in a state that at least a bend radius thereof is set larger than an allowable bend radius.

In the foregoing, the light source portions 100 are mounted on a common liquid cooled jacket. Alternatively, each one of the light source portions 100 may be mounted on a corresponding liquid cooled jacket, or further alternatively, a group of a predetermined number of light source portions 100 may be mounted on a corresponding liquid cooled jacket.

In the following, more concrete examples of an illuminating device and a projector loaded with the illuminating device are described.

### Example 1

### (a) Arrangement of Projector

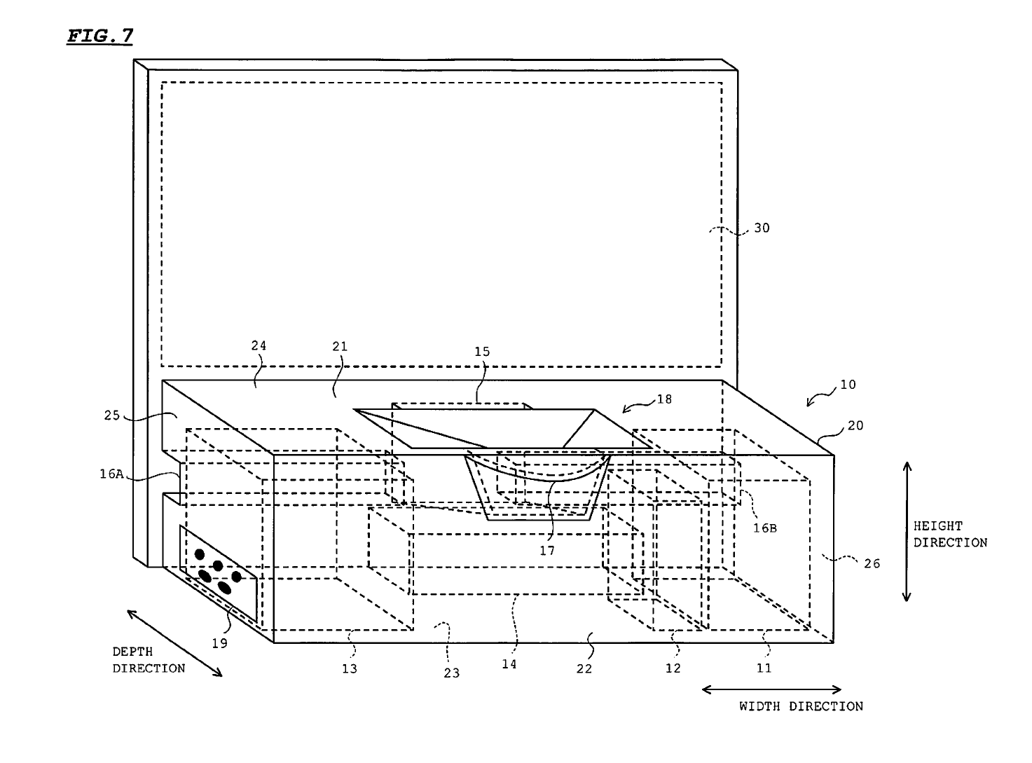

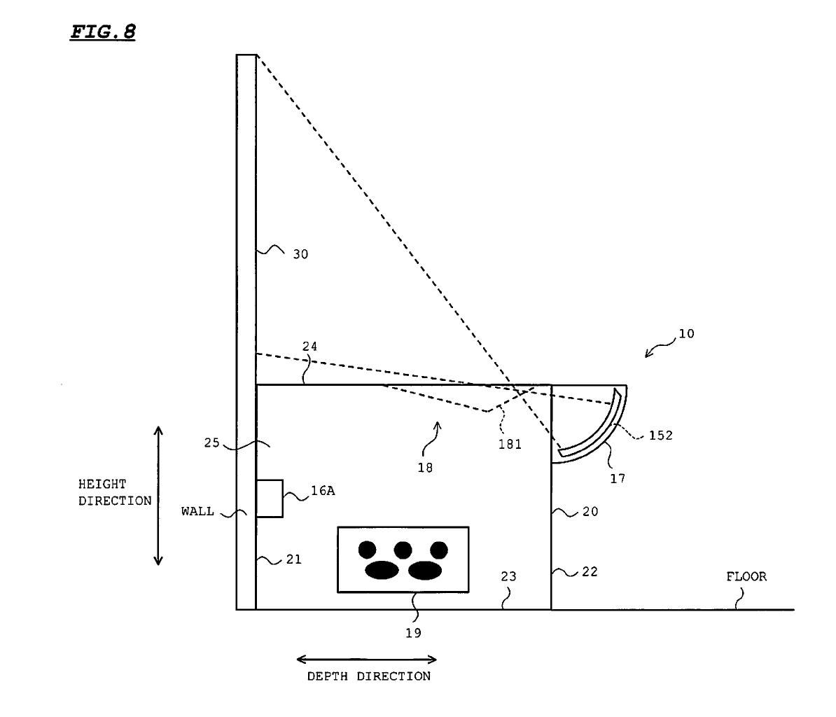

First, an arrangement of a projector loadable with an illuminating device, which is a concrete example of the illuminating devices as the first through the third embodiments, is described referring to the drawings. FIG. 7 is a perspective view of a projector 10. FIG. 8 is a side view of the projector 10.

As shown in FIGS. 7 and 8, the projector 10 includes a casing 20, and is adapted to project an image onto a projection plane 30. The projection plane 30 is e.g. a wall surface. In the case where an image is projected onto a wall surface, the projector 10 is installed along the wall surface and a floor surface. The arrangement of projecting an image onto a wall surface is generally called as wall surface projection.

The casing 20 has a substantially rectangular parallelepiped shape. The sizes of the casing 20 in the depth direction and the height direction in FIG. 7 are smaller than the size of the casing 20 in the width direction. The size of the casing 20 in the depth direction is substantially equal to a throw distance from a reflection mirror (concave surface mirror 152) to the projection plane 30. The size of the casing 20 in the width direction is substantially equal to the size of an image to be projected onto the projection plane 30 in the width direction.

The casing 20 includes side walls 21, 22, 25, and 26, a bottom plate 23, and a top plate 24. A light source unit 11, a power source unit 12, a cooling unit 13, an optical engine 14, and a projection unit 15 are accommodated in a space defined by the side walls 21, 22, 25, and 26, the bottom plate 23, and the top plate 24. The side wall 21 has two recesses 16A and 16B on the side of the projection plane 30. The side wall 22 has a projection 17. The top plate 24 has a recess 18. The side wall 25 has a cable terminal 19.

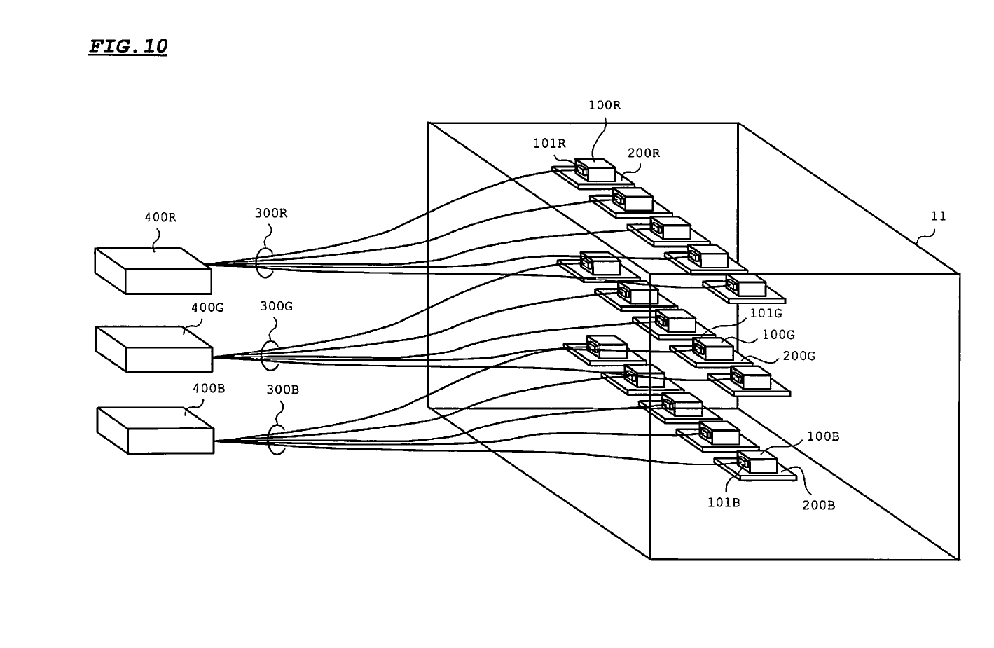

The light source unit 11 has a plurality of light source portions. The light source portions correspond to the light source portions 100 in the first embodiment. The light source unit 11 in the projector is provided with a red light source portion for emitting red component light R, a green light source portion for emitting green component light G, and a blue light source portion for emitting blue component light B. Details on the light source unit 11 will be described later referring to FIG. 10.

The power source unit 12 supplies an electric power to the respective parts in the projector 10. For instance, the power source unit 12 supplies an electric power to the light source unit 11 and the cooling unit 13.

The cooling unit 13 is a unit for cooling the plurality of light source portions provided in the light source unit 11. Specifically, the cooling unit 13 cools the light source portions by cooling a liquid cooled jacket provided with respect to each of the light source portions. The cooling unit 13 is constructed to cool the power source unit 12 and an imager, in addition to the light source portions.

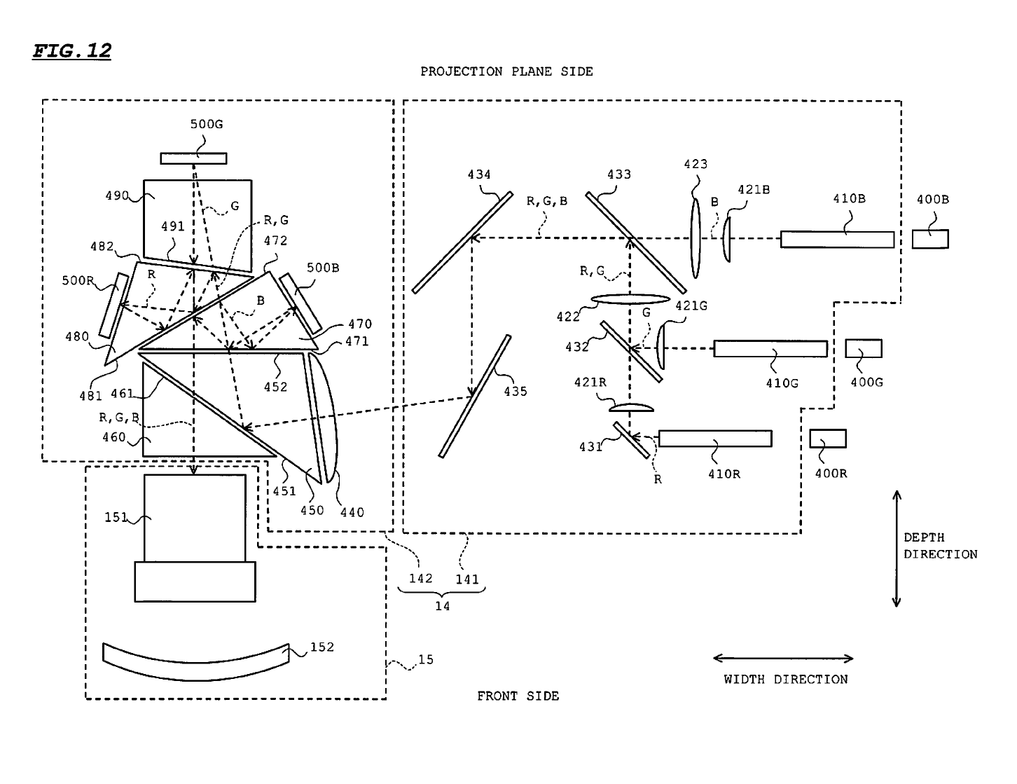

The optical engine 14 modulates laser light to be supplied from the light source unit 11 based on an image signal to generate image light, and emits the generated image light to the projection unit 15. Details on the optical engine 14 will be described later referring to FIG. 12.

The projection unit 15 projects light (image light) emitted from the optical engine 14 onto the projection plane 30. Specifically, the projection unit 15 has a projection lens for projecting light emitted from the optical engine 14 onto the projection plane 30, and a reflection mirror (concave surface mirror) for reflecting the light emitted from the projection lens toward the projection plane 30. Details on the projection unit 15 will be described later referring to FIG. 12.

The recesses 16A and 16B are formed in the side wall 21, and have a shape protruding toward the interior of the casing 20. The recesses 16A and 16B extend from the side wall 25, 26 in the width direction of the casing 20. The recesses 16A and 16B have an air vent communicating with the interior of the casing 20. For instance, the air bent of the recess 16A serves as an air inlet for drawing the external air into the casing 20, and the air vent of the recess 16B serves as an air outlet for discharging the air inside the casing 20 to the exterior.

The projection 17 is formed on the side wall 22, and has a shape protruding toward the exterior of the casing 20. The projection 17 is formed substantially in the middle of the side wall 22 in the width direction of the casing 20. The reflection mirror (concave surface mirror 152) of the projection unit 15 is accommodated in the space in the projection 17.

The recess 18 is formed in the top plate 24, and has a shape protruding toward the interior of the casing 20. The recess 18 has a slope 181 downwardly inclining toward the projection plane 30. The slope 181 has a transmission area where light emitted from the projection unit 15 is transmitted toward the projection plane 30.

The cable terminal 19 is mounted on the side wall 25, and is a terminal such as an electric power terminal or a video terminal. The cable terminal 19 may be mounted on the side wall 26.

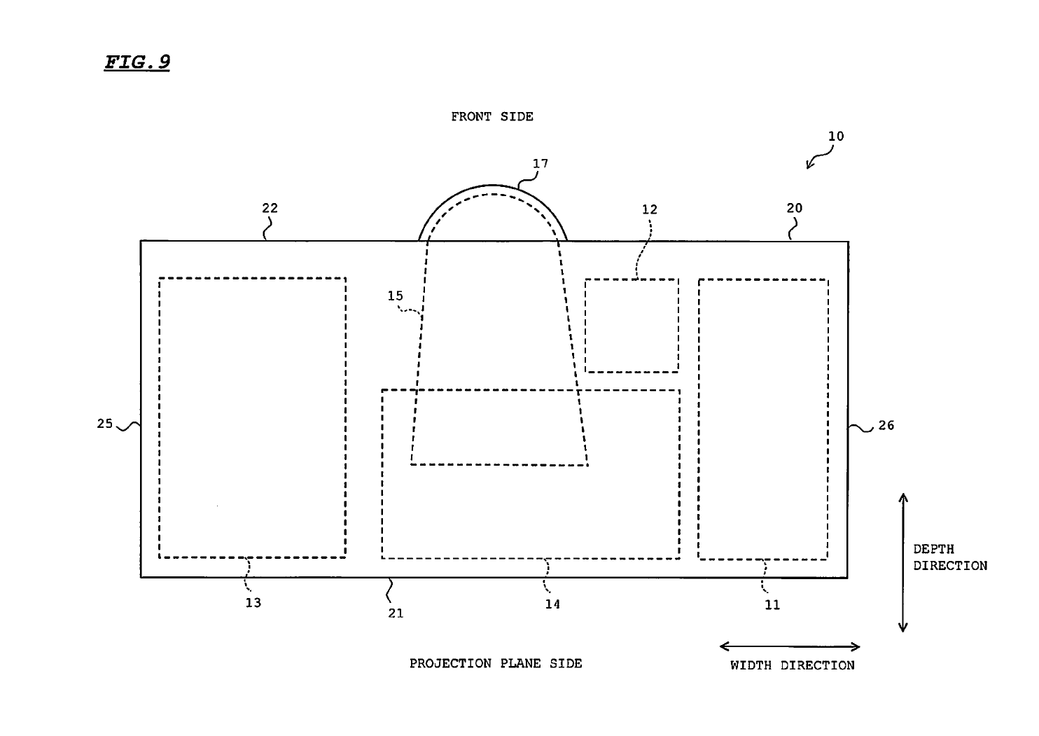

FIG. 9 is a top plan view showing an arrangement state of the respective units of the projector 10.

As shown in FIG. 9, the projection unit 15 is disposed substantially in the middle of the casing 20 in the width direction of the casing 20. The light source unit 11 and the cooling unit 13 are disposed side by side with respect to the projection unit 15 in the width direction of the casing 20. The power source unit 12 is disposed between the projection unit 15 and the light source unit 11 in the width direction of the casing 20.

### (b) Arrangement of Illuminating Device

FIG. 10 is a diagram showing a concrete arrangement example of the illuminating device as the first embodiment.

As shown in FIG. 10, a light source unit 11 includes a plurality of red light source portions 100R, a plurality of green light source portions 100G, and a plurality of blue light source portions 100B.

Each of the red light source portions 100R emits red component light R. Each of the red light source portions 100R has a head 101R, and the head 101R is connected to a corresponding optical fiber 300R. The optical fibers 300R connected to the heads 101R of the respective red light source portions 100R are bundled by a bundling portion 400R. The red light source portions 100R are mounted on respective liquid cooled jackets 200R, and are fixed on the respective liquid cooled jackets 200R by e.g. fastening screws. The red light source portions 100R are cooled by the respective liquid cooled jackets 200R.

Each of the green light source portions 100G emits green component light G. Each of the green light source portions 100G has a head 101G, and the head 101G is connected to a corresponding optical fiber 300G. The optical fibers 300G connected to the heads 101G of the respective green light source portions 100G are bundled by a bundling portion 400G. The green light source portions 100G are mounted on respective liquid cooled jackets 200G, and are fixed on the respective liquid cooled jackets 200G by e.g. fastening screws. The green light source portions 100G are cooled by the respective liquid cooled jackets 200G.

Each of the blue light source portions 100B emits blue component light B. Each of the blue light source portions 100B has a head 101B, and the head 101B is connected to a corresponding optical fiber 300B. The optical fibers 300B connected to the heads 101B of the respective blue light source portions 100B are bundled by a bundling portion 400B. The blue light source portions 100B are mounted on respective liquid cooled jackets 200B, and are fixed on the respective liquid cooled jackets 200B by e.g. fastening screws. The blue light source portions 100B are cooled by the respective liquid cooled jackets 200B.

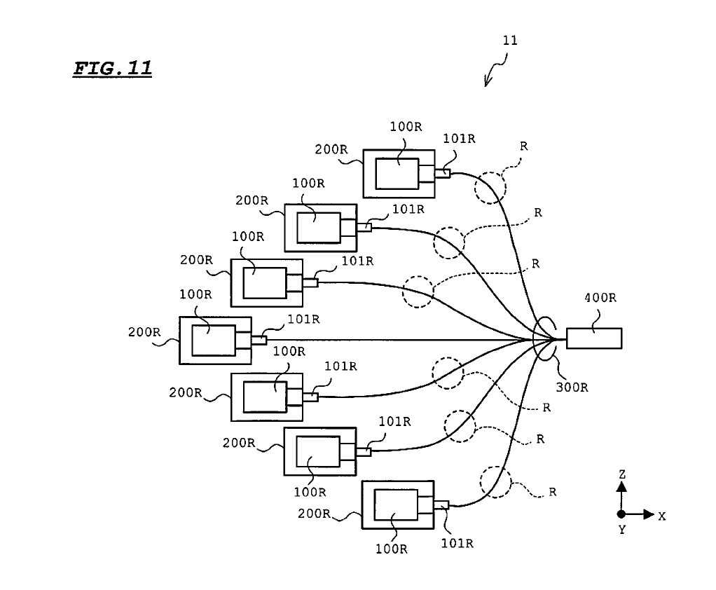

FIG. 10 shows an example, wherein the plurality of red light source portions 100R are arranged in a row. In an actual illuminating device, however, as shown in FIG. 11, the red light source portions 100R are arranged in a V-shape or a substantially arc shape to make the distances between the respective red light source portions 100R and the bundling portion 400R substantially equal to each other. The respective optical fibers 300R are set to have lengths substantially equal to each other. The respective red light source portions 100R are arranged at such positions that the optical fibers 300R are slightly displaced in the optical axis direction from positions where the optical fibers 300R are mounted in a straight state as shown in FIG. 1A. Specifically, each of the optical fibers 300R is mounted in a slightly flexed state so that an incident end and an exit end thereof are respectively aligned substantially in parallel to the optical axis of the corresponding red light source portion 100R and the central axis of the bundling portion 400R. Accordingly, each of the optical fibers 300R has a bent portion R. The bend radius of the respective bent portions R is set larger than at least an allowable bend radius of the respective optical fibers 300R. In this case, however, the respective optical fibers 300R are arranged at such positions as to be mounted in a state close to a straight state, with a flexure thereof being suppressed as much as possible.

The allowable bend radius is a threshold value of bend radius where the use efficiency of light to be transmitted through an optical fiber becomes equal to or larger than an allowable efficiency. Specifically, as the bend radius of the optical fiber 300 becomes smaller than the allowable bend radius, the use efficiency of light to be transmitted through the optical fiber 300 is lowered than the allowable efficiency.

FIG. 11 shows a positional relation between the red light source portions 100R, the optical fibers 300R, and the bundling portion 400R. The green light source portions 100G, the optical fibers 300G, and the bundling portion 400G; and the blue light source portions 100B, the optical fibers 300B, and the bundling portion 400B are arranged in the similar manner as described above.

FIGS. 10 and 11 show a concrete arrangement example of the illuminating device as the first embodiment. Specifically, in this example, as shown in FIG. 11, the red light source portions 100R are arranged at such positions that the red light source portion 100R located farther away from the central axis of the bundling portion 400R in the direction (in this example, Z-axis direction) perpendicular to the central axis has a reduced distance with respect to the bundling portion 400R in the direction (in this example, X-axis direction) parallel to the central axis of the bundling portion 400R. The illuminating device as the second embodiment can be constructed in the similar manner as described above.

Specifically, in the second embodiment, as shown in FIGS. 5A and 5B, the red light source portions 100R are arranged in an arc shape or a substantially arc shape to make the distances between the respective red light source portions 100R and the bundling portion 400R substantially equal to each other. In this case, the respective red light source portions 100R are arranged at such positions that the optical fibers 300R are slightly displaced in the optical axis direction from positions where the optical fibers 300R are mounted in a straight state as shown in FIG. 5A. In other words, each of the optical fibers 300R is arranged in a slightly flexed state so that the incident end and the exit end thereof are respectively aligned substantially in parallel to the optical axis of the corresponding red light source portion 100R and the central axis of the bundling portion 400R. Accordingly, each of the optical fibers 300R has a bent portion R. The bend radius of the respective bent portions R is set larger than at least an allowable bend radius of the respective optical fibers 300R. In this case, however, the respective optical fibers 300R are arranged at such positions as to be mounted in a state close to a straight state, with a flexure thereof being suppressed as much as possible. Similarly to the above, the green light source portions 100G, the optical fibers 300G, and the bundling portion 400G; and the blue light source portions 100B, the optical fibers 300B, and the bundling portion 400B are arranged at such positions that the optical fibers 300G and 300B are mounted in a slightly flexed state from the state shown in FIGS. 5A and 5B.

### (c) Arrangement of Optical Engine

FIG. 12 is a diagram showing an arrangement of the optical engine 14 and the projection unit 15. In this example, an imager system corresponding to a DLP (Digital Light Processing) system (registered trademark) is shown.

As shown in FIG. 12, the optical engine 14 includes a first unit 141 and a second unit 142. The first unit 141 supplies combined light obtained by combining red component light R, green component light G, and blue component light B to the second unit 142. The second unit 142 modulates the combined light to generate image light, and allows the generated image light to be entered into the projection unit 15.

The first unit 141 has rod integrators 410R, 410G, and 410B, lenses 421R, 421G, 421B, 422, and 423, and mirrors 431, 432, 433, 434, and 435.

The rod integrator 410R makes uniform the red component light R to be emitted from the optical fibers 300R bundled by the bundling portion 400R. The rod integrator 410G makes uniform the green component light G to be emitted from the optical fibers 300G bundled by the bundling portion 400G. The rod integrator 410B makes uniform the blue component light B to be emitted from the optical fibers 300B bundled by the bundling portion 400B.

The rod integrator 410R, 410G, 410B may be a hollow rod with an inner surface thereof configured to be a reflection surface, or a solid rod made of a glass material. In this example, the rod integrator 410R, 410G, 410B is disposed, with a longitudinal direction thereof being substantially aligned in the width direction of the casing 20.

The lens 421R is a lens for substantially collimating red component light R so that the red component light R is irradiated onto a DMD 500R. The lens 421G is a lens for substantially collimating green component light G so that the green component light G is irradiated onto a DMD 500G. The lens 421B is a lens for substantially collimating blue component light B so that the blue component light B is irradiated onto a DMD 500B.

The lens 422 is a lens for substantially forming an image of red component light R and green component light G on the DMD 500R and the DMD 500G, while suppressing expansion of the red component light R and the green component light G. The lens 423 is a lens for substantially forming an image of blue component light B on the DMD 500B, while suppressing expansion of the blue component light B.

The mirror 431 reflects the red component light R emitted from the rod integrator 410R. The mirror 432 is a dichroic mirror for reflecting the green component light G emitted from the rod integrator 410G, and transmitting the red component light R. The mirror 433 is a dichroic mirror for transmitting the blue component light B emitted from the rod integrator 410B, and reflecting the red component light R and the green component light G. The mirror 432 combines the red component light R and the green component light G. Further, the mirror 433 combines the light obtained by combining the red component light R and the green component light G, with the blue component light B to generate combined light.

The mirrors 434 and 435 reflect the combined light and guide the reflected combined light to the second unit 142. Although in FIG. 12, the respective elements are illustrated in a plan view to simplify the description, the mirror 435 reflects the red component light R, the green component light G, and the blue component light B obliquely in the height direction.

The second unit 142 separates the combined light containing the red component light R, the green component light G, and the blue component light B, and modulates the separated red component light R, green component light G, and blue component light B, respectively. Further, the second unit 142 re-combines the modulated red component light R, green component light G, and blue component light B to generate image light, and supplies the generated image light to the projection unit 15.

Specifically, the second unit 142 includes a lens 440, a prism 450, a prism 460, a prism 470, a prism 480, a prism 490, and the DMDs 500R, 500G, and 500B.

The lens 440 is a lens for substantially collimating light emitted from the first unit 141 so that the light of the respective color components is irradiated onto the respective DMDs.

The prism 450 has a surface 451 and a surface 452, and an air gap is defined between the surface 451 and a surface 461. In this example, since combined light from the first unit 141 is entered into the surface 451 with an angle larger than the total reflection angle, the combined light is reflected on the surface 451. An air gap is also defined between the surface 452 and a surface 471. Since combined light reflected on the surface 451 is entered into the surface 452 with an angle smaller than the total reflection angle, the combined light is transmitted through the surface 452.

The prism 460 has the surface 461.

The prism 470 has the surface 471 and a surface 472. The surface 472 is a dichroic mirror surface for transmitting red component light R and green component light G, and reflecting blue component light B. Accordingly, out of the combined light transmitted through the surface 452, the red component light R and the green component light G are transmitted through the surface 472, and the blue component light B is reflected on the surface 472. Since the blue component light B reflected on the surface 472 is entered into the surface 471 with an angle larger than the total reflection angle, the blue component light B is reflected on the surface 471, and guided to the DMD 500B. Then, the blue component light B is modulated by the DMD 500B. The blue component light B emitted from the DMD 500B is entered into the surface 471 again with an angle larger than the total reflection angle, and reflected on the surface 471. The blue component light B reflected on the surface 471 is reflected on the surface 472.

The prism 480 has a surface 481 and a surface 482. The surface 482 is a dichroic mirror surface for transmitting green component light G and reflecting red component light R. Accordingly, out of the green component light G and the red component light R transmitted through the surface 481, the green component light G is transmitted through the surface 482, and the red component light R is reflected on the surface 482.

Since the red component light R reflected on the surface 482 is entered into the surface 481 with an angle larger than the total reflection angle, the red component light R is reflected on the surface 481 and guided to the DMD 500R. Then, the red component light R is modulated by the DMD 500R. The red component light R emitted from the DMD 500R is entered into the surface 481 again with an angle larger than the total reflection angle, and reflected on the surface 481. The red component light R reflected on the surface 481 is reflected on the surface 482 again. Since the red component light R reflected on the surface 482 is entered into the surface 481 with an angle smaller than the total reflection angle, the red component light R is transmitted through the surface 481.

The prism 490 has a surface 491. The surface 491 is configured to transmit green component light G. The green component light G transmitted through the surface 482 and the surface 491 is guided to the DMD 500G for modulation. The green component light G emitted from the DMD 500G is transmitted through the surface 491.

The DMD 500R, 500G, 500B is constituted of a plurality of micro-mirrors. The micro-mirrors are movable. Each of the micro-mirrors basically corresponds to one pixel. The DMD 500R is operable to switch whether red component light R is to be reflected toward the projection unit 15 by changing the angle of the respective micro-mirrors. Similarly, the DMD 500G and the DMD 500B are operable to switch whether green component light G and blue component light B are to be reflected toward the projection unit 15 by changing the angle of the respective micro-mirrors.

The prism 470 separates combined light including red component light R and green component light G, and blue component light B by the surface 472. The prism 480 separates red component light R and green component light G by the surface 482. The cutoff wavelength of the surface 472 of the prism 470 is set between the wavelength band corresponding to green and the wavelength band corresponding to blue. The cutoff wavelength of the surface 482 of the prism 480 is set between the wavelength band corresponding to red and the wavelength band corresponding to green.

On the other hand, the prism 480 combines red component light R and green component light G on the surface 482. Further, the prism 470 combines red component light R, green component light G, and blue component light B on the surface 472. Thus, the red component light R, the green component light G, and the blue component light B modulated by the DMDs 500R, 500G, and 500B are combined to generate image light. The generated image light is transmitted through the prisms 450 and 460 and emitted to the projection unit 15.

The projection unit 15 includes a projection lens 151 and the concave surface mirror 152.

The projection lens 151 emits image light entered from the optical engine 14 toward the concave surface mirror 152. The concave surface mirror 152 reflects the image light entered from the projection lens 151. The concave surface mirror 152 condenses the image light and diverges the image light. For instance, the concave surface mirror 152 is an aspherical mirror having a concave surface on the side of the projection lens 151.

The image light condensed on the concave surface mirror 152 is transmitted through the transmitting area formed on the slope 181 of the recess 18 formed in the top plate 24. Preferably, the transmitting area formed on the slope 181 may be formed near a position where image light is condensed by the concave surface mirror 152.

As described above, the concave surface mirror 152 is accommodated in the space in the projection 17. For instance, preferably, the concave surface mirror 152 may be fixed to the inner surface of the projection 17. Further preferably, the inner surface of the projection 17 may have a shape in conformity with the shape of the concave surface mirror 152.

In the arrangement of Example 1, the plurality of optical fibers (optical fibers 300R, 300G, and 300B) are set to have lengths substantially equal to each other. Accordingly, the optical fibers can be detached from the heads (heads 101R, 101G, and 101B) and connected to heads of the other light source portions, without changing the arrangement positions of the respective light source portions (red light source portion 100R, green light source portion 100G, and blue light source portion 100B). In other words, optical fibers to be connected to the light source portions can be replaced, as necessary. This enables to easily determine in which position in the bundling portion, laser light from a targeted light source portion is to be guided, with respect to the optical fibers bundled by the bundling portion (bundling portion 400R, 400G, and 400B). Thus, since the lengths of the respective optical fibers are set substantially equal to each other, a shortage or an excess in the lengths of the optical fibers can be avoided even if combination of the light source portions and the optical fibers is changed. Specifically, in the arrangement of Example 1, combination of the light source portions and the optical fibers can be easily changed while suppressing lowering of the use efficiency of light. Thus, changing the combination of the light source portions and the optical fibers enables to suppress a color nonconformity of a projected image.

Further, in Example 1, the respective light source portions are arranged at such positions that the distances between the respective light source portions and the bundling portion are substantially equal to each other. Accordingly, the lengths of the respective optical fibers can be easily determined so that the bend radius of the respective optical fibers becomes not smaller than the allowable bend radius.

### Example 2

In this section, Example 2, as an improved example of Example 1 is described referring to a drawing. In the following, Example 2 is described mainly on a point different from Example 1. In Example 2, an arrangement for changing the distances between respective light source portions 100 and a bundling portion 400 is provided.

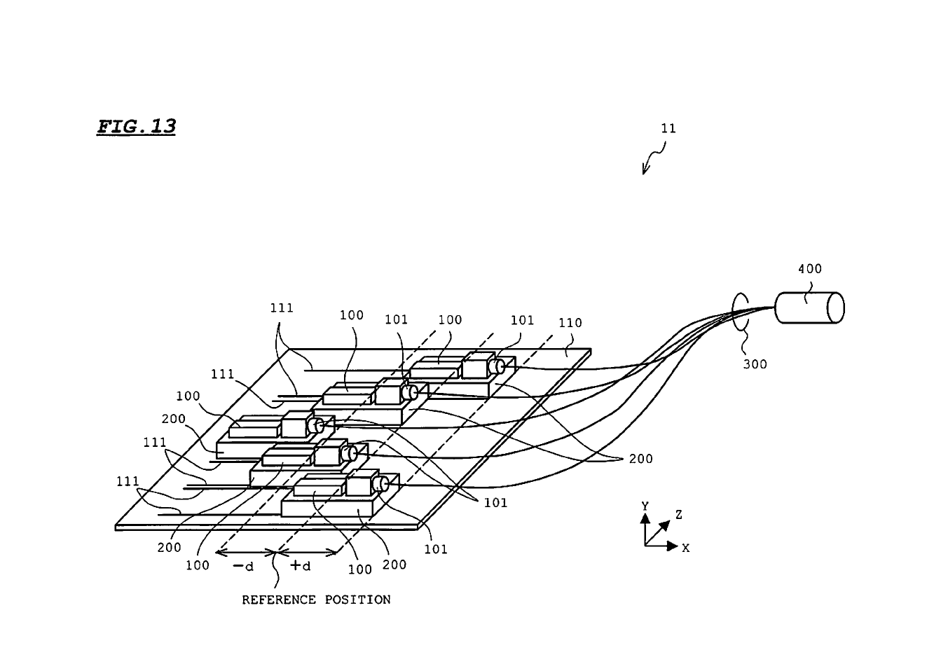

FIG. 13 is a diagram showing a part of a light source unit 11 in Example 2.

As shown in FIG. 13, the respective light source portions 100 are fixed on respective corresponding liquid cooled jackets 200. The liquid cooled jackets 200 are mounted on a slide mechanism (e.g. rails 111) provided on a base block 110. Each of the liquid cooled jacket 200 is slidably moved along the corresponding rails 111.

In other words, each of the light source portions 100 fixed on the corresponding liquid cooled jacket 200 is constructed to be slidably movable along the corresponding rails 111 together with the corresponding liquid cooled jacket 200. Specifically, each of the light source portions 100 is slidably moved along the corresponding rails 111 in such a manner that the distance between the each light source portion 100 and the bundling portion 400 is changeable in the range of ±d with respect to a reference position.

In Example 2, each of the light source portions 100 fixed on the corresponding liquid cooled jacket 200 is slidably moved along the corresponding rails 111 to change the distance between the each light source portion 100 and the bundling portion 400. In this arrangement, even if optical fibers 300 connected to the respective light source portions 100 have lengths substantially equal to each other, a shortage or an excess in the length of an optical fiber 300 can be eliminated by slidably moving the corresponding light source portion 100. In other words, there can be avoided a likelihood that a bend radius of the respective optical fibers 300 may become smaller than an allowable threshold value.

### Example 3

Similarly to Example 2, in Example 3, an arrangement for changing the distances between respective light source portions 100 and a bundling portion 400 is provided.

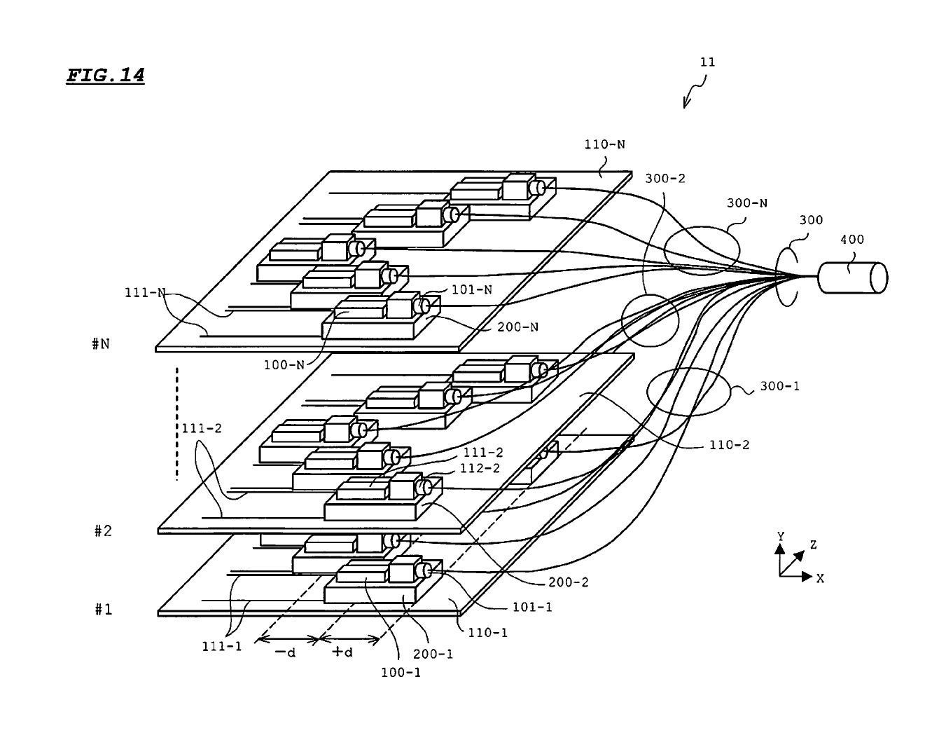

FIG. 14 is a diagram showing a part of a light source unit 11 in Example 3.

The light source unit 11 is constituted of a plurality of stages #1 through #N. In each of the stages, a plurality of light source portions 100 are fixed on respective corresponding liquid cooled jackets 200, and the liquid cooled jackets 200 are mounted on a slide mechanism (e.g. rails 111) provided on a base block 110.

Specifically, in the stage #1, light source portions 100-1 are fixed on respective corresponding liquid cooled jackets 200-1, and the liquid cooled jackets 200-1 are mounted on a slide mechanism (e.g. rails 111-1) provided on a base block 110-1. The arrangements on the stages #2 through #N are substantially the same as the arrangement on the stage #1.

In Example 3, the lengths of optical fibers 300 connected to the light source portions 100 are different from each other between the stages. For instance, the length of an optical fiber 300-1 connected to the corresponding light source portion 100-1 on the stage #1 is different from the length of an optical fiber 300-2 connected to a corresponding light source portion 100-2 on the stage #2.

On the other hand, the lengths of the optical fibers 300 are substantially equal to each other, as far as the optical fibers 300 are mounted on the same stage. For instance, the lengths of the respective optical fibers 300-1 connected to the respective corresponding light source portions 100-1 on the stage #1 are substantially equal to each other.

### Example 4

In Example 3, the lengths of the respective optical fibers 300 connected to the respective corresponding light source portions 100 are different from each other between the stages. On the other hand, in Example 4, the lengths of respective optical fibers 300 are grouped depending on a reference position (e.g. the arrangement position of a bundling portion 400). In the following, Example 4 is described mainly on a point different from Example 3.

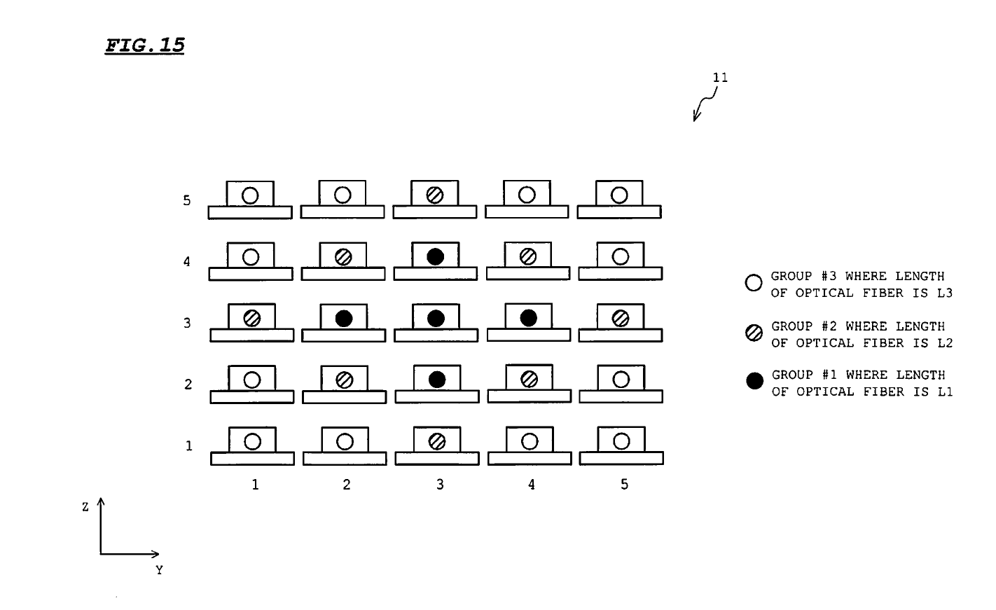

Grouping of the lengths of the respective optical fibers 300 is described referring to FIG. 15. FIG. 15 is a diagram of light source portions 100 viewed from light exit ends side thereof. In other words, FIG. 15 is a diagram showing an arrangement order of the light source portions 100.

As shown in FIG. 15, the arrangement positions of the respective light source portions 100 are defined by Y axis and Z axis. In other words, the arrangement positions of the respective light source portions 100 are expressed by (Y, Z). In Example 4, described is case where the arrangement position of a bundling portion 400 is (Y, Z)=(3, 3).

In this example, the optical light source portions 100 are grouped into a group #1 where the lengths of the optical fibers 300 are L1, a group #2 where the lengths of the optical fibers 300 are L2 (>L1), and a group #3 where the lengths of the optical fibers 300 are L3 (>L2).

As described above, the light source portions 100 are concentrically grouped with the arrangement position (3, 3) being defined as a center. The light source portions 100 are grouped in such a manner that the light source portion 100 whose arrangement position is closer to the arrangement position (3, 3) i.e. the arrangement position of the bundling portion 400 belongs to the group where the lengths of the optical fibers 300 are shorter.

### Example 5

Similarly to Examples 1 through 4, the illuminating device as the third embodiment may be configured into the following example.

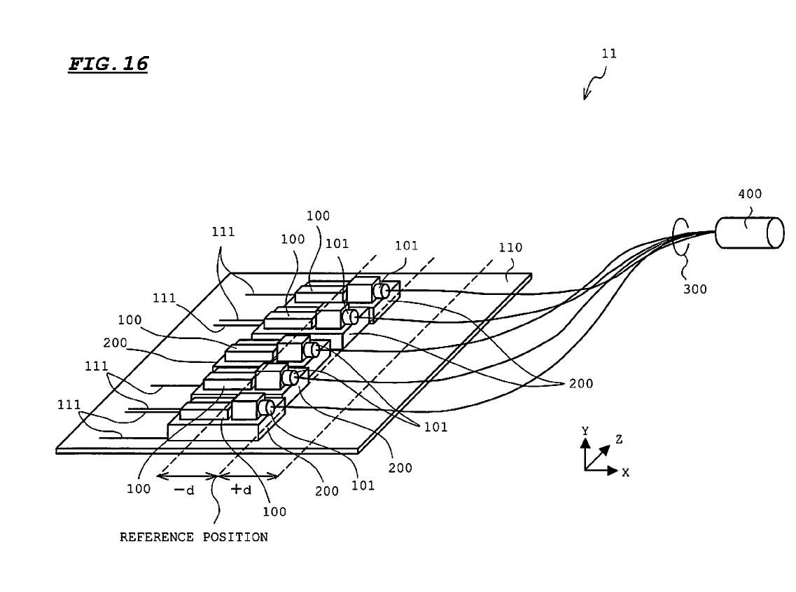

FIG. 16 is a diagram showing an arrangement example of a light source unit 11 corresponding to FIG. 13. Respective light source portions 100 are fixed on respective corresponding liquid cooled jackets 200. The respective liquid cooled jackets 200 are mounted on a slide mechanism (e.g. rails 111) provided on a base block 110. Each of the liquid cooled jackets 200 is slidably moved along the corresponding rails 111.

As described referring to FIGS. 6A and 6B, the lengths of the respective optical fibers 300 are made different from each other in such a manner that a flexure of the respective optical fibers 300 is suppressed, and the respective optical fibers 300 are mounted in a state close to a straight state. The respective optical fibers 300 are arranged in a slightly flexed state so that an incident end and an exit end of each of the optical fibers 300 are respectively aligned substantially in parallel to an optical axis of the corresponding light source portion 100 and the central axis of the bundling portion 400.

Similarly to the arrangement shown in FIG. 10, the light source unit 11 having the above arrangement is provided with respect to each of the colors, and the light source units 11 are incorporated in the projector shown in FIGS. 7 through 9. As an arrangement of an optical system in the projector, for instance, the optical system shown in FIG. 12 is used. The arrangement shown in FIG. 14 or the arrangement shown in FIG. 15 may also be applicable to Example 5.

### Other Examples

In the foregoing section, Examples 1 through 5 are described as the detailed arrangement examples of the illuminating device and the projector. The present invention may be modified based on an arrangement other than Examples 1 through 5, as necessary.

For instance, in Example 1, the projection plane 30 is formed on a wall surface in proximity to the casing 20. Alternatively, the projection plane 30 may be formed at a position away from the casing 20 with respect to a wall surface. Further, FIG. 9 merely shows an arrangement example of the respective units, and the arrangement positions of the respective units (light source unit 11, power source unit 12, and cooling unit 13) may be freely set.

In FIG. 12, the DMDs are shown as imagers. Alternatively, an optical system incorporated with a transmissive liquid crystal panel or a reflective liquid crystal panel may be used as an imager, as necessary.

In Example 3 shown in FIG. 14, the lengths of the optical fibers 300 connected to the respective corresponding light source portions 100 are different from each other between the stages. Alternatively, the lengths of all the optical fibers 300 connected to the respective corresponding light source portions 100 may be substantially equal to each other between the stages. In the modification, preferably, the base blocks 110 provided at the respective stages may be constructed to be slidably movable in such a manner that the distances between the respective light source portions 100 and the bundling portion 400 are changeable with respect to each of the stages.

In Examples 1 through 4, a flexure of the respective optical fibers 300 is suppressed by arranging the light source portions 100 in a V-shape or a substantially arc shape. In Example 5, a flexure of the respective optical fibers 300 is suppressed by adjusting the lengths of the respective optical fibers 300. Alternatively, a flexure of the respective optical fibers 300 may be suppressed so that the respective optical fibers 300 are mounted in a state close to a straight state by arranging the light source portions 100 in a V-shape or a substantially arc shape, and making the lengths of the respective optical fibers 300 different from each other.

The embodiments, the modifications, and the concrete examples of the present invention have been described as above. The present invention is not restricted to the foregoing arrangements. The embodiments of the present invention may be modified in various ways, as necessary, as far as such modifications do not depart from the scope of the technical idea of claims of the present invention hereinafter defined.

### Reference Example 1

The methods shown in the following Reference Examples 1 through 4 may be used, as other methods for reducing a luminance nonuniformity of illumination light. These methods may be embraced in the claims of the present invention, as necessary.

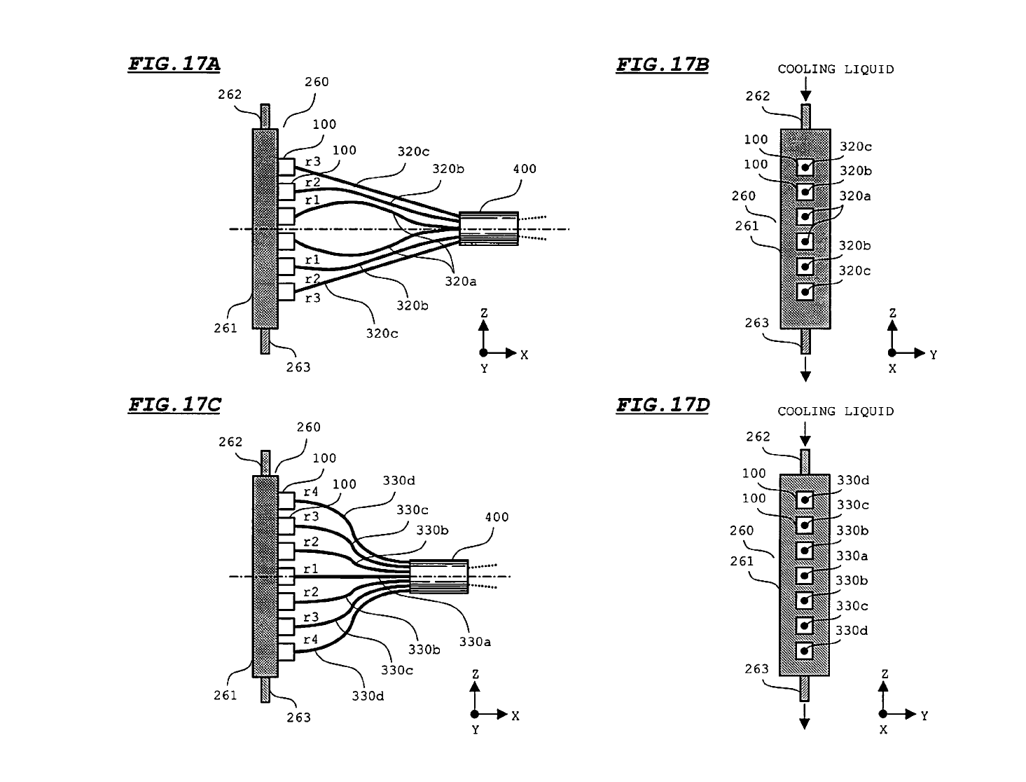

FIGS. 17A, 17B, 17C, and 17D are diagrams showing arrangements of an illuminating device as Reference Example 1. FIGS. 17A and 17B are respectively a side view and a front view of an illuminating device, as a first arrangement example of Reference Example 1. In FIG. 17B, a bundling portion is omitted to simplify the description.

Referring to FIGS. 17A and 17B, the illuminating device as the first arrangement example of Reference Example 1 is constituted of a plurality of light source portions 100, a liquid cooled jacket 260, a plurality of optical fibers 320a, 320b, and 320c, and a bundling portion 400.

The arrangement of the illuminating device is substantially the same as the arrangement of the third embodiment except for the arrangement of the optical fibers 320a through 320c. In the first arrangement example, however, the number of the light source portions 100 to be mounted on the liquid cooled jacket 260 is e.g. six, which is also different from the arrangement of the third embodiment in a strict sense. However, the number of the light source portions 100 may be changed, as necessary.

In the following, the arrangement of the optical fibers 320a through 320c, which is different from the arrangement of the third embodiment, is mainly described.

In the first arrangement example of Reference Example 1, the lengths of the optical fibers 320a through 320c are set substantially equal to each other. Accordingly, the distance of the respective light source portions 100 with respect to the bundling portion 400 is decreased, as the light source portion 100 is arranged at a position closer to the arrangement center of the light source portions 100. Further, a flexure of the respective optical fibers at a portion on the way to the bundling portion 400 is increased in the order of the optical fiber 320a closest to the arrangement center, the optical fiber 320b at an outer position than the optical fiber 320a, and the optical fiber 320c at an outermost position with respect to the arrangement center.

In view of the above, in the first arrangement example of Reference Example 1, allowable bend radiuses of the optical fibers are adjusted in such a manner that the allowable radiuses r1, r2, and r3 of the optical fiber 320a closest to the arrangement center, the optical fiber 320b at the outer position than the optical fiber 320a, and the optical fiber 320c at the outermost position are reduced in the order of r1, r2, and r3.

An optical fiber having a small allowable bend radius is less likely to change the angle distribution, as compared with an optical fiber having a larger allowable bend radius. Specifically, an optical fiber having a small core diameter has a small allowable bend radius, and a reflection state on an inner wall of the core is less likely to change when the optical fiber is bent. Accordingly, the angle distribution of the optical fiber is less likely to change.

In the above arrangement, even if there is a large difference in flexure between the optical fibers 320a through 320c, a large difference in brightness-darkness pattern is less likely to be generated in light to be emitted from the optical fibers 320a through 320c. Thus, according to the above arrangement example, a luminance nonuniformity of illumination light can be easily reduced by providing optical means for suppressing a brightness-darkness pattern, as necessary.

FIGS. 17C and 17D are respectively a side view and a front view of an illuminating device as a second arrangement example of Reference Example 1. In FIG. 17D, a bundling portion is omitted to simplify the description.

In the second arrangement example of Reference Example 1, an optical fiber 330a closest to the arrangement center of light source portions is shortest, and an optical fiber 330d at an outermost position with respect to the arrangement center is longest. Accordingly, the outermost optical fiber 330d is most likely to bend. In the second arrangement example of Reference Example 1, allowable bend radiuses of the optical fibers are adjusted in such a manner that the allowable radiuses r4, r3, r2, and r1 of the outermost optical fiber 330d, an optical fiber 330c at an inner position than the outermost optical fiber 330d, an optical fiber 330b at a further inner position than the outermost optical fiber 330d, and the optical fiber 330a closest to the arrangement center are reduced in the order of r4, r3, r2, and r1.

Similar to the first arrangement example, in the above arrangement, a large difference in brightness-darkness pattern is also less likely to be generated in light to be emitted from the optical fibers 330a through 330d. Thus, a luminance nonuniformity of illumination light can be easily reduced by providing optical means for suppressing a brightness-darkness pattern, as necessary.

### Reference Example 2

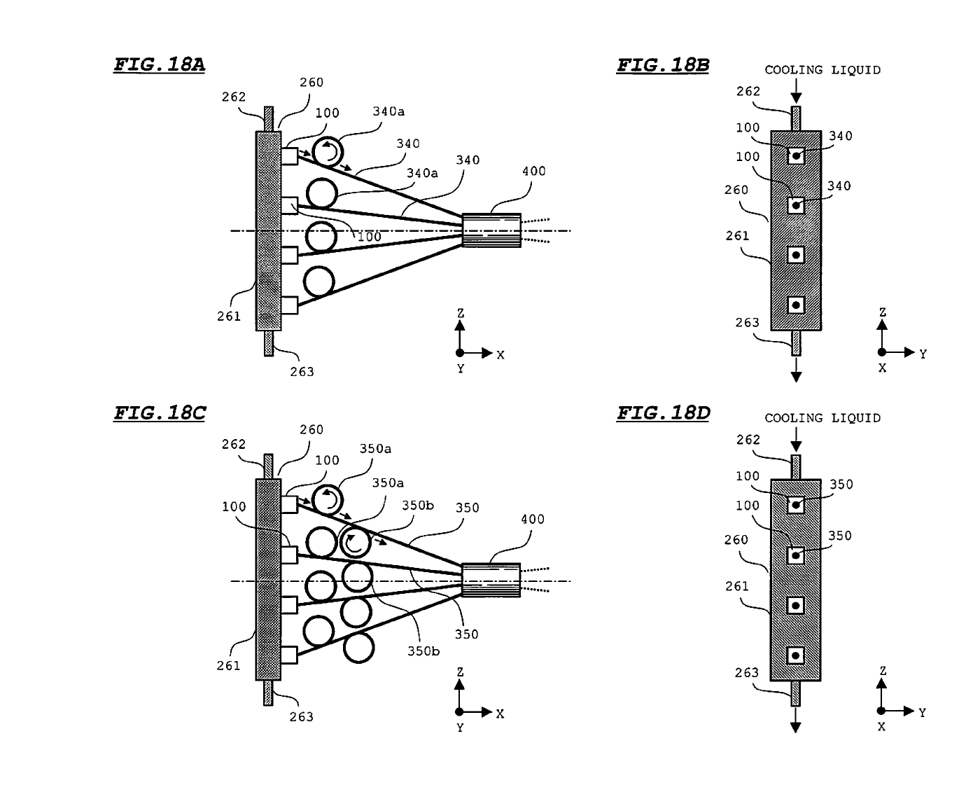

FIGS. 18A, 18B, 18C, and 18D are diagrams showing arrangements of an illuminating device as Reference Example 2. FIGS. 18A and 18B are respectively a side view and a front view of an illuminating device as a first arrangement example of Reference Example 2. In FIG. 18B, a bundling portion is omitted to simplify the description.

Referring to FIGS. 18A and 18B, the illuminating device as the first arrangement example of Reference Example 2 is constituted of a plurality of light source portions 100, a liquid cooled jacket 260, a plurality of optical fibers 340, and a bundling portion 400.

The arrangement of the illuminating device is substantially the same as the arrangement of the third embodiment except for the arrangement of the optical fibers 340. In the first arrangement example, however, the number of the light source portions 100 to be mounted on the liquid cooled jacket 260 is e.g. four, which is also different from the arrangement of the third embodiment in a strict sense. However, the number of the light source portions 100 may be changed, as necessary.

In the following, the arrangement of the optical fibers 340, which is different from the arrangement of the third embodiment, is mainly described.

Each of the optical fibers 340 has a loop portion 340a at a portion on the way to the bundling portion 400, with a curvature radius thereof being reduced than the allowable bend radius.

In the above arrangement, the angle distribution of light is made uniform by repeating light reflection through the loop portion 340a. As a result, a difference in brightness and darkness of laser light to be emitted from the respective optical fibers 340 is reduced. Thus, a luminance nonuniformity of illumination light can be reduced.

In the arrangement example shown in FIGS. 18A and 18B, each of the optical fibers 340 has the single loop portion 340a. Alternatively, each of the optical fibers 340 may have two or more loop portions.

FIGS. 18C and 18D are diagrams showing a second arrangement example of Reference Example 2. In the second arrangement example, each of optical fibers has two loop portions 350a and 350b. In this arrangement example, winding directions of the two loop portions 350a and 350b are made opposite to each other. This arrangement enables to increase the frequency of light reflections through the loop portions 350a and 350b, as compared with the first arrangement example. Accordingly, the effect of making the angle distribution uniform can be enhanced. Thus, a luminance nonuniformity of illumination light can be further reduced.

### Reference Example 3

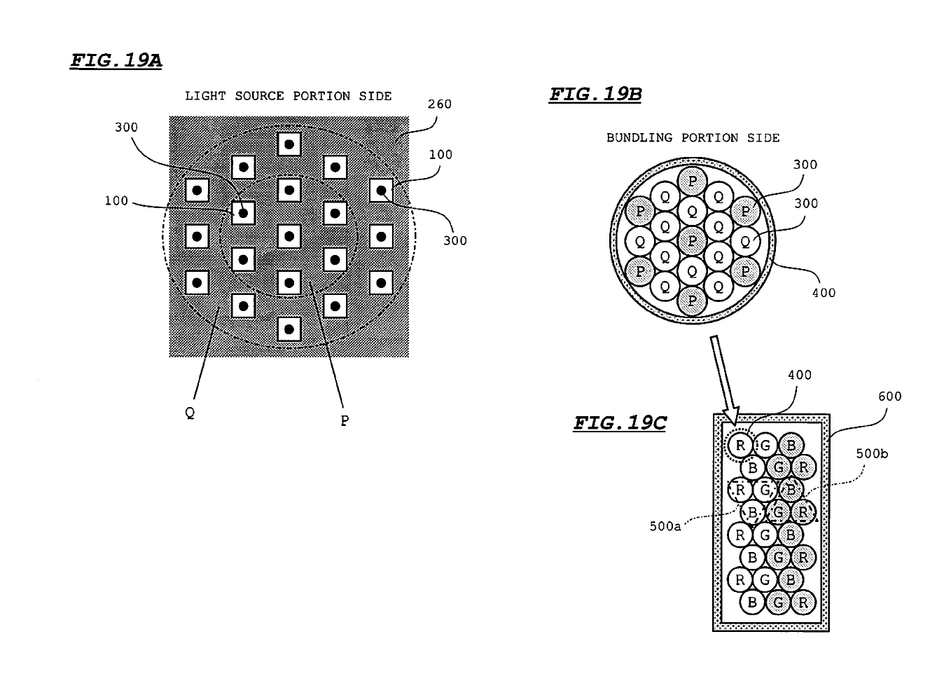

FIGS. 19A, 19B, and 19C are diagrams showing an arrangement of an illuminating device as Reference Example 3. FIG. 19A shows an arrangement state of light source portions on a liquid cooled jacket. FIG. 19B shows a bundled state of optical fibers in a bundling portion. FIG. 19C shows an arrangement state of RGB colors, in the case where a white light illumination unit is constructed by combining a plurality of illuminating devices.

As shown in FIG. 19A, a plurality of light source portions 100 are two-dimensionally arranged on a mounting surface of a liquid cooled jacket 260.

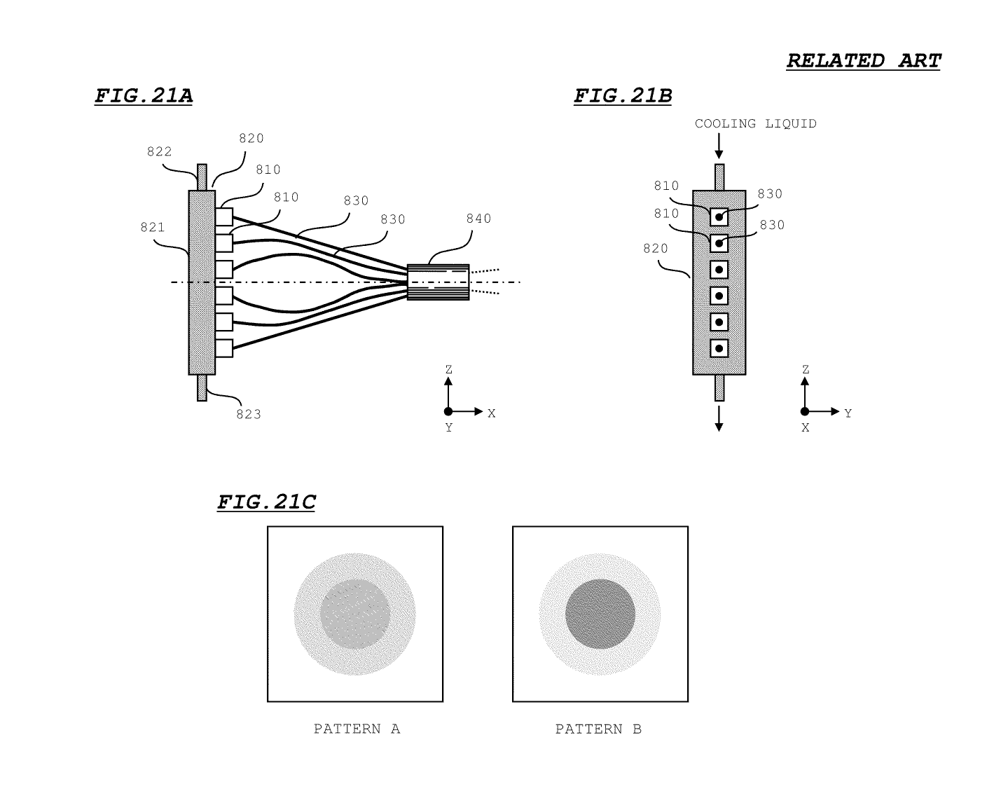

The mounting surface of the liquid cooled jacket 260 is flat, and the distance from the respective light source portions 100 to a bundling portion 400 is increased, as the light source portion 100 is arranged farther away from the arrangement center of the light source portions 100. Further, all the lengths of the optical fibers 300 corresponding to the respective light source portions 100 are set substantially equal to each other. Accordingly, when the optical fibers 300 are bundled by the bundling portion 400, the optical fibers 300 corresponding to the light source portions 100 at a central area P are mounted in a flexed state, and the optical fibers 300 corresponding to the light source portions 100 at a peripheral area Q are mounted in a straight state (see FIG. 21A).

Accordingly, brightness-darkness patterns of laser light to be emitted from the optical fibers 300 at the central area P become similar to each other, and brightness-darkness patterns of laser light to be emitted from the optical fibers 300 at the peripheral area Q become similar to each other.

On the other hand, the optical fibers 300 at the central area P are discretely arranged, without being arranged in a concentrated manner at a central portion in the bundling portion 400. For instance, as shown in FIG. 19B, the optical fibers 300 at the central area P and the optical fibers 300 at the peripheral area Q are alternately arranged in a radial direction of the bundling portion 400. In FIG. 19B, the symbols P and Q respectively indicate the optical fibers 300 at the central area P and the optical fibers 300 at the peripheral area Q. The bundling portion 400 bundles the optical fibers 300 in such a manner that the optical fibers 300 whose brightness-darkness patterns are different from each other at exit ends thereof are arranged adjacent to each other.

In the above arrangement, there is no likelihood that laser light whose brightness-darkness patterns are similar to each other may be emitted from a central portion in a bundling portion in a concentrated manner. Accordingly, there is no or less likelihood that a brightness-darkness pattern may be adversely affected on laser light to be emitted from the illuminating device. Thus, a luminance nonuniformity of illumination light can be reduced.

In the case where white light is generated by combining the bundling portions 400 for emitting red component light R, green component light G, and blue component light B, as shown in FIG. 19C, two RGB units 500a and 500b, wherein arrangement states of bundling portions 400 for emitting red component light R, green component light G, and blue component light B are different from each other, are prepared in a plurality of sets. In FIG. 19C, the symbols R, G and B respectively indicate bundling portions 400 for emitting red component light R, green component light G, and blue component light B. These RGB units 500a and 500b are bundled by a bundling portion 600. Each two sets of the RGB units 500a and 500b are arranged side by side within the bundling portion 600.

The above arrangement enables to emit white light with less luminance nonuniformity from an illumination unit, as compared with an arrangement that a plurality of single RGB units are regularly arranged in a bundling portion 600.

In the above arrangement, preferably, as shown in FIG. 19C, the bundling portion 400 for emitting R light having a less influence of refractive index on an optical component, as compared with B light and G light may be arranged at an outer position with respect to the bundling portions 400 for emitting B light and G light in the bundling portion 600.

### Reference Example 4

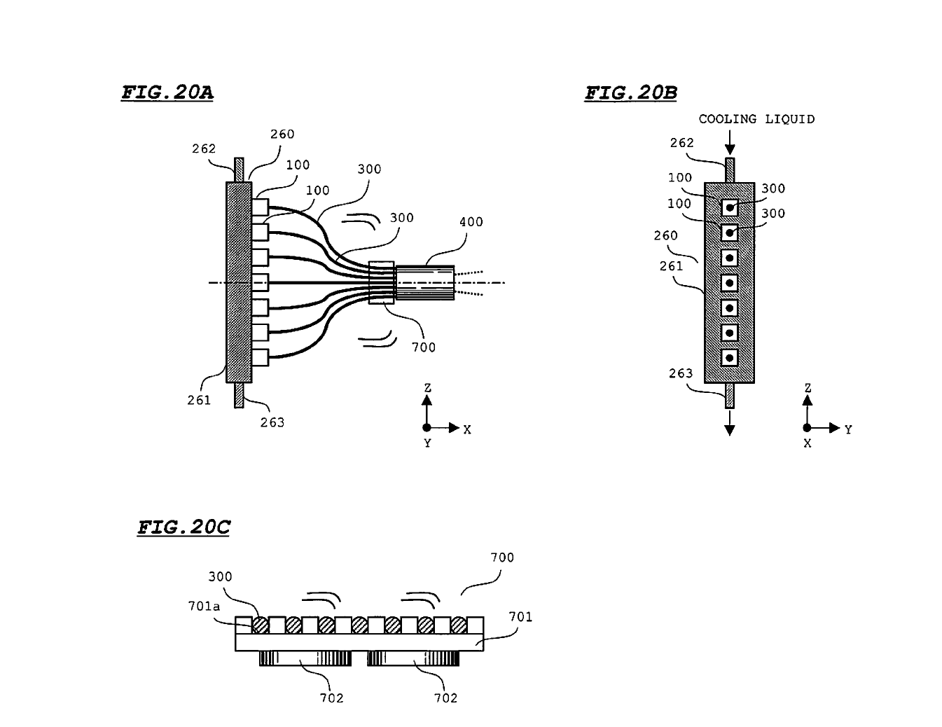

FIGS. 20A, 20B, and 20C are diagrams showing an arrangement of an illuminating device as Reference Example 4. FIGS. 20A and 20B are respectively a side view and a front view of the illuminating device. In FIG. 20B, a bundling portion is omitted to simplify the description. FIG. 20C shows an arrangement of a vibrating unit.

The illuminating device includes a vibrating unit 700 for vibrating optical fibers 300, in addition to light source portions 100, a liquid cooled jacket 260, the optical fibers 300, and a bundling portion 400.

The vibrating unit 700 is constituted of a fiber holding portion 701, and two vibrating motors 702. The fiber holding portion 701 has a plurality of grooves 701a for receiving the respective corresponding optical fibers 300. The vibrating motors 702 are mounted on the rear surface of the fiber holding portion 701.

In this arrangement, when the vibrating motors 702 are vibrated, vibrations of the vibrating motors 702 are transmitted to the optical fibers 300 via the fiber holding portion 701, thereby vibrating the optical fibers 300.

When the optical fibers 300 are vibrated, the degree of flexure of the optical fibers 300 is varied in a short time. As a result, a brightness-darkness pattern is varied in a short time. The vibration frequency of the vibrating unit 700 is set to such a value (60 Hz or more) that a variation in brightness-darkness pattern cannot be recognized by a human eye. Accordingly, the user recognizes light whose brightness-darkness pattern is made uniform.

In the above arrangement, there is no or less likelihood that the user's eyes may perceive a brightness nonuniformity. Thus, by incorporating the illuminating device having the above arrangement in a projector, there is no or less likelihood that the user may recognize a brightness nonuniformity in a projected image.

What is claimed is:

1. An illuminating device comprising:
a plurality of light source portions for emitting light;
a plurality of optical fibers for guiding the light emitted from the respective light source portions to an object to be illuminated; and
a bundling portion for bundling the optical fibers, wherein
an arrangement for suppressing a flexure of each of the optical fibers in the case where the each optical fiber is mounted between the corresponding light source portion and the bundling portion is provided on both or either one of the light source portion and the optical fiber.

2. The illuminating device according to claim 1, wherein
the light source portions are arranged at such positions that the light source portion located farther away from a central axis of the bundling portion in a direction perpendicular to the central axis has a reduced distance with respect to the bundling portion in a direction parallel to the central axis.

3. The illuminating device according to claim 1, wherein
the light source portions are arranged in an arc shape or a substantially arc shape to make distances between the respective light source portions and the bundling portion substantially equal to each other.

4. The illuminating device according to claim 2, further comprising:
a support portion for supporting the light source portions, wherein
the support portion includes an adjusting portion for adjusting the distances between the respective light source portions and the bundling portion.

5. The illuminating device according to claim 4, wherein
the light source portions are supported on the support portion by way of a cooling portion for cooling the light source portions.

6. The illuminating device according to claim 1, wherein
the respective optical fibers have different lengths from each other depending on the distances between the respective light source portions and the bundling portion.

7. The illuminating device according to claim 6, further comprising:
a support portion for supporting the light source portions, wherein
the support portion includes an adjusting portion for adjusting the distances between the respective light source portions and the bundling portion.

8. The illuminating device according to claim 7, wherein
the light source portions are supported on the support portion by way of a cooling portion for cooling the light source portions.

9. A projection display device comprising:
an illuminating device;
a light modulator for modulating light emitted from the illuminating device based on an image signal; and
a projecting section for projecting the light modulated by the light modulator onto a projection plane,
the illuminating device including
a plurality of light source portions for emitting light;
a plurality of optical fibers for guiding the light emitted from the respective light source portions to an object to be illuminated; and
a bundling portion for bundling the optical fibers, wherein
an arrangement for suppressing a flexure of each of the optical fibers in the case where the each optical fiber is mounted between the corresponding light source portion and the bundling portion is provided on both or either one of the light source portion and the optical fiber.

10. The projection display device according to claim 9, wherein
the light source portions are arranged at such positions that the light source portion located farther away from a central axis of the bundling portion in a direction perpendicular to the central axis has a reduced distance with respect to the bundling portion in a direction parallel to the central axis.

11. The projection display device according to claim 9, wherein
the light source portions are arranged in an arc shape or a substantially arc shape to make distances between the respective light source portions and the bundling portion substantially equal to each other.

12. The projection display device according to claim 10, further comprising:
a support portion for supporting the light source portions, wherein
the support portion includes an adjusting portion for adjusting the distances between the respective light source portions and the bundling portion.

13. The projection display device according to claim 12, wherein
the light source portions are supported on the support portion by way of a cooling portion for cooling the light source portions.

14. The projection display device according to claim 9, wherein
the respective optical fibers have different lengths from each other depending on the distances between the respective light source portions and the bundling portion.

15. The projection display device according to claim 14, further comprising:
a support portion for supporting the light source portions, wherein
the support portion includes an adjusting portion for adjusting the distances between the respective light source portions and the bundling portion.

16. The projection display device according to claim 15, wherein
the light source portions are supported on the support portion by way of a cooling portion for cooling the light source portions.
